(19) United States
(12) Patent Application Publication
(10) Pub. No.: US 2014/0200934 A1
(43) Pub. Date: Jul. 17, 2014

(54) GAME ENTRY

(71) Applicant: Sudhir Agarwala, Cambridge Cambs (GB)

(72) Inventor: Sudhir Agarwala, Cambridge Cambs (GB)

(73) Assignee: PATERNOSTER HOLDINGS LLC, Mahe (SC)

(21) Appl. No.: 14/239,763

(22) PCT Filed: Aug. 20, 2012
(86) PCT No.: PCT/GB2012/052035

§ 371 Date: Feb. 19, 2014

(30) Foreign Application Priority Data
Aug. 19, 2011 (GB) 114351.8
Nov. 21, 2011 (GB) 1120074.8
Nov. 23, 2011 (GB) 1120246.2

(51) Int. Cl. G06Q 30/02; G06Q 10/02

(52) U.S. Cl. CPC G06Q 30/0226; G06Q 10/02; G06Q 30/0212
USPC 705/5; 705/14.27; 705/14.14

(57) ABSTRACT

An apparatus for use in a points redemption system in relation to a customer loyalty program includes a data input to receive an input from a user that points are to be redeemed for entry to a game. A request is sent to a server to indicate that a game is to be entered, identifying an associated terminal. Information indicative of the outcome of the game is sent to the user. A server connected to a communications network is configured for handling requests for item promotion reservations.

### FIELD OF THE INVENTION

The invention relates to apparatus for use in a points redemption system. The invention also relates to apparatus for managing item promotion reservation, and also to apparatus for a product promotion system. The invention further relates to related methods and computer programs.

### BACKGROUND

Generally, retailers and other vendors seek to attract and retain customers in a number of ways. A customer loyalty programme is a useful tool for companies, for example supermarkets, to attract, retain and gather information on customers. Customer loyalty programmes are used by many companies. In such programmes, a customer may acquires point and may redeem the points against a company's products or services. The cost to many companies of implementation of such a programme is high. It is an object of aspects of the present invention to reduce that cost.

Many companies promote particular products using various forms of advertising. The promotion may involve incentivising customers to buy a product by informing them that by purchasing the product there is the possibility of winning a prize. The customer may be informed of whether a prize has been won or whether the customer has an entry to a prize draw by text on the interior of a product's wrapping. Alternatively, the product's wrapping may include a code, on the interior or exterior, with details of a website at which to enter the code or a number to text to gain entry to a draw. After the customer enters or texts the code, he or she is informed of whether a prize has been won. It is an object of aspects of the present invention to provide an improved possibility for product promotion.

Various systems for use in retail stores are known. US2009/0224037A1 discloses a system including a central controller and a plurality of point-of-sale terminals. A shopper selects one or more products to purchase and brings the products to a point-of-sale terminal. A customer identifying code is then entered into the point-of-sale terminal using a shopper identification card. The central controller then determines an outcome selected by a random or pseudo-random process from among a plurality of possible outcomes. The outcome may be a cash prize or a product that the shopper has not selected for purchase. Such a system does not allow for such product promotion.

It is an object of the present invention to address issues in the above mentioned systems and generally to provide improved item promotion systems and/or customer loyalty programmes.

### SUMMARY OF THE INVENTION

According to a first aspect of the present invention, there is provided apparatus for a points redemption system relating to a customer loyalty programme offered by a vendor in which points are awarded to a customer against purchases of any one or more of a plurality of items offered for sale by the vendor, the apparatus comprising: at least one data input means for receiving input, initiated by a user, of an indication that at least one point is to be redeemed against entry to a game; sending means for sending a request to a server means, the request including an indication that a game is to be entered, wherein at least one prize that can be won by entry to the game comprises a progressive jackpot, and an identifier of a terminal comprising the sending means; and means for receiving information indicative of an outcome of the game comprising whether the progressive jackpot has been won, and communicating the outcome to the user.

The purchaser may have an option to redeem the points against entry to a game instead of goods or services. The points redemption system can be configured so that redemption of points against games costs the vendor less than redemption against goods or services.

The apparatus may be a point-of-sale terminal configured for purchase of items by a purchaser, for example in a retail store such as a supermarket. The PoS terminal may be self-service terminal. The identifier of the terminal may be the internet protocol (IP) address or the like.

The at least one data input means may be configured to receive input of data identifying or associated with a number of points redeemable. For example, the data input means may be configured to read a voucher presented by the purchaser. The data input means may be configured as a chip reader and the data input by reading of data from the chip may identify points residing in a customer account registered to the purchaser.

The at least one data input means may be configured to read data on a medium attached to items to be purchased, said data comprising an identifier of the particular item. For example, the data reader may be configured for reading a bar code on an item to be purchased or on a paper or electronic voucher.

The at least one data input means may be configured to receive input, initiated by the purchaser, of information identifying a customer, and said sending means is arranged to send to the server means, together with said indication and the terminal identifier, the information identifying the customer. Additionally or alternatively to the information identifying a customer, the information may identify a customer account. These may allow points associated with a customer account to be debited from that account on redemption against one or more items. Advantageously, in the event that a game is won, a degree of authentication of the winner can be achieved. The information identifying a customer account may comprise information identifying the purchaser.

The at least one data input means may comprise a user interface, for example a keypad. Each user interface comprises at least a touch screen display and a controller operable by the purchaser to control play of the at least one game. The voucher identifier may be input by a purchaser using the keypad. Information identifying the customer or the customer account may be entered using the keypad.

There may be further provided apparatus for a points redemption system for a customer loyalty programme, comprising a server means connected to a communications network, and a plurality of electronic terminals, each in accordance with the above description. The server means may be arranged, responsive to the request, to determine an outcome of the game and to send information indicative of the outcome to the terminal identified by the terminal identifier for the terminal to receive and communicate to the purchaser.

The apparatus may further comprise a plurality of further terminals configured to handle purchase of items. In this case, each further terminal is configured to provide a voucher to the purchaser in exchange for redemption of points, and the data input to the terminal indicating that a game is to be entered comprises information readable from the voucher.

According to a second aspect of the present invention, there is provided a method of redeeming points by a user in relation to a customer loyalty programme offered by a vendor in which points are awarded to a customer against purchases of any one or more of a plurality of items offered for sale by the vendor: receiving input, initiated by a user, at a terminal of an indication that at least one point is to be redeemed against entry to a game; sending, responsive to the receiving, a request to the server means, the request including an indication that a game is to be entered, wherein at least one prize available to be won by entry to the game comprises a progressive jackpot value, and an identifier of a (the or another) terminal operated by or for the user; and receiving, at the terminal operated by or for the user, information indicative of an outcome of the game, the outcome comprising whether the progressive jackpot has been won, and communicating the outcome to the user.

In another aspect, there is provided a system configured to enable a user to redeem customer loyalty points against entry to a progressive jackpot draw in which the value of the jackpot is incremented when an outcome of entry is a lose. In the above aspects relating to a point redemption, it should be understood that, points are awarded to a customer for purchase of one or more of a plurality of items. The items may include a variety of different kinds of item, for example groceries, clothing, white goods, etc.

Further aspects of the present invention are set out in the appended independent and dependent claims.

In any aspect of the invention in which a code is sent to a user for use in entering a game, it should be understood that operation at the first apparatus may be under the control of a first entity and operation at the second apparatus may be under the control of a second entity. The first and second entities are preferably separate organisations. The first and second apparatus may respectively be in the form of first and second server means. The first and second apparatus may be at a single server means. The at least one product may be purchased by the customer at an online store and/or physical store, from the first entity. The second entity may be a manufacturer or distributor of products, which is promoting its products through the first entity's store(s). Operation at the second apparatus may be under the control of a third party, for example a specialist customer loyalty programme provider. Aspects of operation at the first apparatus may be controlled by the third party. For example, the third party may receive identifiers of promoted items that have been purchased from the first entity, and perform the other steps of the aforementioned methods. In particular, the customer may enter the code at a website of the second entity or the third party, and either may process the game and send an indication of the outcome to the customer.

### BRIEF DESCRIPTION OF DRAWINGS

Embodiments of the invention will now be described, by way of example only, with reference to the accompanying drawings in which:

FIG. 1 is a schematic diagram of hardware elements of a server in accordance with embodiments of the present invention;

FIG. 2 is a schematic diagram of hardware elements at a point-of-sale terminal in accordance with embodiments of the invention;

FIG. 3 is a schematic diagram of a points redemption system for stores in accordance with embodiments of the invention;

FIG. 4 is a schematic diagram of the data provided in a database at a server;

FIGS. 5A and 5B are flow diagrams indicating steps at the point-of-sale terminal in a process of redeeming points against a game;

FIG. 6 is a flow diagram indicating steps at a server in the process of redeeming points against a game;

FIG. 7 is a schematic diagram of a points redemption system in accordance with other embodiments of the present invention, wherein the points are redeemed following an internet purchase;

FIGS. 8A and 8B are flow diagrams indicating steps at a terminal in a process of redeeming points against a game in accordance with internet embodiments;

FIG. 9 is a schematic diagram of a product promotion system in accordance with embodiments;

FIG. 10 is a flow diagram indicating steps at a PoS terminal, in accordance with embodiments, in a process of buying a promoted product;

FIG. 11 is a schematic diagram of a product promotion system in accordance with online embodiments of the invention;

FIG. 12 is flow diagram indicating steps at a user terminal in a process of buying a promoted product in accordance with online embodiments of the product promotion system;

FIG. 13 is a flow diagram indicating steps at the point-of-sale terminal in a process of buying a promoted product in a store;

FIG. 14 is a flow diagram indicating steps at a server when a customer buys promoted products;

FIG. 15 is a flow diagram indicating steps at a server operable by an item promoter when a customer buys promoted products;

FIG. 16 is a flow diagram of steps that take place at a customer device connected to the internet when the customer buys promoted products online;

FIG. 17 is a schematic diagram of a system, which may be implemented in a product promotion or a points redemption system, comprising separate point of sale and gaming terminals in a store;

FIG. 18 is a flow diagram indicating steps at the point-of-sale terminal in a process of buying a promoted product in an embodiment;

FIG. 19 is a flow diagram indicating steps at the gaming terminal in the embodiment;

FIG. 20 is a flow diagram indicating steps at the point-of-sale terminal in a process of buying a promoted product in another embodiment; and

FIG. 21 is a flow diagram indicating steps at the gaming terminal in the other embodiment.

### DETAILED DESCRIPTION OF EMBODIMENTS

Like elements and steps are denoted by like reference numerals throughout. Titles in the following are not to be interpreted as limiting.

Embodiments of the invention will be described implemented as points redemption systems or product promotion systems, or terminals and servers relating thereto, although in other embodiments such systems may be integrated. These systems can be implemented in apparatus including electronic point-of-sale (PoS) terminals in which operation of the system is initiated by a purchaser at a one of the PoS terminals, and/or in apparatus including internet-connected user terminals operable by a purchaser. The user terminals may be conventional computers and, in use, are connected to a communications network and typically run a web browser. Embodiments of the invention are not limited to any particular number of terminals. In each case a server arrangement is connected to the terminals (that is, the PoS terminals or the user terminals) over a communications network.

In the embodiments described below, the communications network is the internet. However, the invention is not limited by the kind of communications network. The communications network may comprise more than one kind of network. For example, terminals could be connected to a local area network (LAN), which is connected to the internet.

Connections between the server arrangement and the terminals, and between servers in the server arrangement, are secure and can be implemented, for example, by using the secure socket layer (SSL) or by implementing a virtual private network (VPN) between the elements.

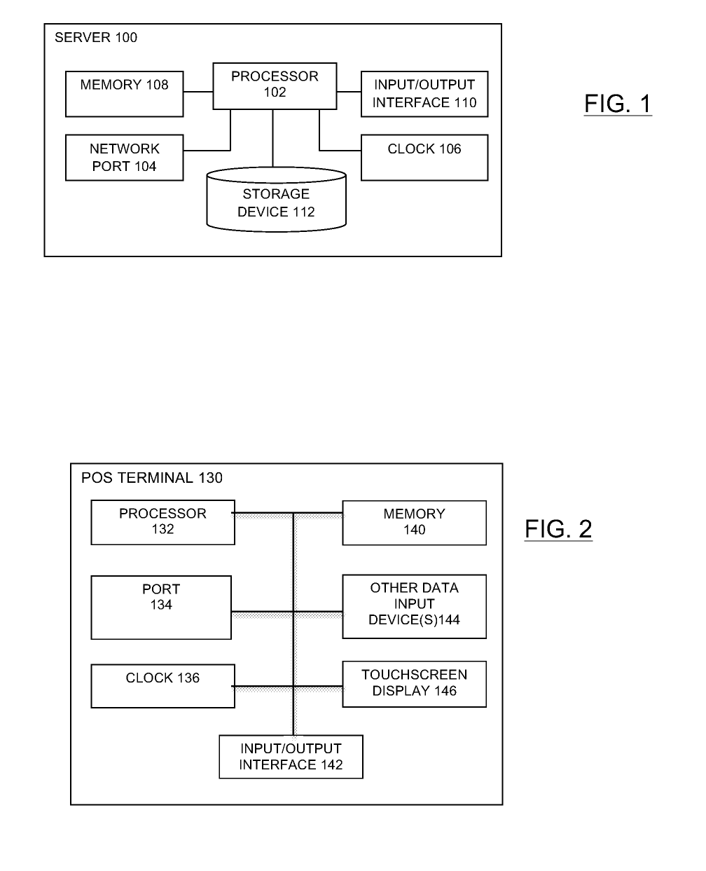

The server arrangement is in the form of a server. Turning to FIG. 1, the hardware components of the server, indicated at 100, comprise a first processor 102, one or more network ports 104, an internal clock 106 which controls the timing of operations performed by the processor 102, a memory 108, an input/output interface 110 and a mass storage device 112. The components are operatively coupled via a local interface (not shown), which can be, for example, one or more buses or other wired or wireless connections.

It should be understood that the server arrangement may be in the form of a plurality of networked servers. It may be desirable for the server arrangement to be formed of at least two servers each connected to the communications network and capable of communicating with each other thereover. In particular, applications running on such servers may be operated by separate entities which each provide different aspects of the possible systems, for example where the customer loyalty system is provided by a third party.

The processor 102 can be custom made or be a commercially available processor or central processing unit (CPU), or generally any device for executing software instructions. The network port 104 enables communication via the communications network. The memory 108 can include any one of a combination of volatile memory elements (e.g. random access memory elements (RAM, such as DRAM, SRAM, SDRAM, etc)) and non-volatile memory elements (such as ROM) to provide fixed and working data storage for the processor. The input/output interface 110 may connect, for example, to an operator terminal (not shown). Alternatively, input/output interfaces may be absent. The mass storage device 112 can be integral to the server 100, or external. The mass storage device 112 stores information and software, including databases/stores and a control application.

The control application is implemented by suitable computer program code (not shown) stored on the mass storage device 112 or memory 108, and which, when executed by the processor, causes the server 100 to provide the functionality described herein, particularly any one of the methods ascribed to the server 100 described herein.

The processor 102 can be a single processor or a number of networked processor networked by any conventional communications network. The control application can be in the form of one or several modules providing aspects of the functionality of the server 100. Alternatively, the control application can be implemented in dedicated processing equipment or a mixture of dedicated hardware and software.

The storage device 112 stores the control application and databases/stores. The databases and their potential use and structure will be described in greater detail below. As would be understood by the person skilled in the art, the schematic illustrations and accompanying descriptions of the databases are exemplary arrangements for storing information. A number of other arrangements may be employed. Not all of the databases/stores will be used or needed in every embodiment.

The server is also referenced with numbers 200, 300, 400 and 500 in the following embodiments. It should be understood however that such servers may comprise the same hardware as the server described at 100. The software may also comprise the same elements, but be modified in a manner that will be clear in the context to provide the functionality of the particular embodiment(s).

Embodiments in Stores

In embodiments of the invention in which the terminals comprise PoS terminals, the PoS terminals are grouped into groups. The groups of PoS terminals may be located in respective venues. For example, the PoS terminals in one group may be located in a store belonging to an entity and the PoS terminals in another group may be located in another store belonging to the entity. The embodiments are not limited to any particular number or groups or venues. The venues, for example, might be retail stores such as supermarkets. A venue may only have a single PoS terminal, for example, if the store is small.

FIG. 2 indicates components of the architecture of a typical PoS terminal 130. Each PoS terminal 130 may be implemented with a conventional architecture, including components such as a processor 132 that is in communication with one or more network ports 134, an internal clock 136 which controls the timing of operations performed by the processor 138, a memory 140, and an input/output interface 142 connected to a touchscreen display 144 and typically at least one other data input device 144. Stored in either the memory 140 or a local mass storage device (not shown) is a software application for controlling operation of the PoS terminal 130. The components are operatively coupled via a local interface (not shown), which can be, for example, one or more buses or other wired or wireless connections. The memory 140 can include any one of combination of volatile memory elements (e.g. random access memory elements (RAM, such as DRAM, SRAM, SDRAM, etc)) and non-volatile memory elements (such as ROM) to provide fixed and working data storage for the processor 132.

Typically, the at least one data input device includes a machine readable data reader for reading machine readable data from items to be purchased, for example a barcode scanner. The machine readable data comprises an identifier of the item and the PoS terminal is configured so that the customer is charged appropriately for the item and typically to notify a stock control server (not shown) of the purchase.

The data reader may also be configured to read data from vouchers and/or customer loyalty cards, although alternatively another one or more data input device may be provided for this purpose. The data input device may also input a payment card reader. This may also be configured to read from customer loyalty cards.

The software application is implemented by suitable computer program code (not shown) stored in the memory 140 and which, when executed by the processor 132, causes the PoS terminal to provide the functionality described herein. In the embodiments described below, the PoS terminals may be self service checkouts, and/or the checkouts may be operated by a checkout assistant.

The PoS terminal's software application can be in the form of one or several modules providing aspects of the functionality of the PoS terminal 130. Alternatively, the PoS software application can be implemented in dedicated processing equipment or a mixture of dedicated hardware and software.

The terminal is also referenced with numbers 150, 250, 350, 450 and 550 in the following embodiments. It should be understood however that such terminals may comprise the same hardware as the server described at 130. The software may also comprise the same elements, but be modified in a manner that will be clear in the context to provide the functionality of the particular embodiment(s).

Display systems are preferably located in each of the venues and operate under the control of the server 100 communicating over the communications network. Each display system includes processing apparatus, a network interface, a screen and optionally a speaker and optionally peripheral LED lights. The display system is for informing persons in the venue of information relating to the game(s) and prize(s), for example to advertise that a game may be entered and how this is done. The server 100 provides control of content to be displayed to the display systems and each display system is configured to play such content. The display systems are indicated at 156 throughout in the description below of the embodiments.

In embodiments, the terminal 130 may include a second display connected to the input/output interface 142. The second display may be used to display the outcome of a game. This is particularly advantageous where the terminal is operated by a checkout assistant.

Optionally, a person may receive a notification on a mobile device (for example a smartphone, PDA, tablet, etc) when entering a store regarding current promotions or of prizes available in exchange for points. This may be achieved, for example, by the person holding their mobile device near a near field communications (NFC) communications terminal.

Customer Loyalty Programmes

Many entities use customer loyalty programmes, in which a customer is registered with a programme and has a customer account. Customer loyalty programmes can be used in relation to online purchases at user terminals running a web browser, user terminals running applications enabling purchasing, for example as may be found on a mobile device, or purchases at PoS terminals in stores. Contact details of a customer are typically stored in a customer data store at a server, for example one or more of: the customer's email address, telephone number and physical address.

The customer loyalty programme may be administered by the entity itself. In this case, when a customer purchases from the entity, points may be assigned to the customer's customer account for redemption against purchases from the entity by the customer and/or item purchases may be tracked by the entity. Instead, such a customer loyalty programme may be administered by a third party. A customer loyalty programme may be used by a number of entities (that is, separate organisations), and be administered by a third party, for example the Nectar® customer loyalty programme in the UK. In this case, when a customer purchases from any of the entities using the programme, points are assigned to the customer's customer account. The points can typically be redeemed against purchases from any of the entities by the customer. Points may be accepted against purchases from entities who are not part of the loyalty programme; some entities do not issue points, but redeem points awarded by another entity. Such programmes are also used to gather information on customers and customers' buying habits, so as to have purchasing histories for customers.

There exist online points exchange websites allowing transfer of points from numerous worldwide loyalty programmes to others, or even transfer and/or exchange of points between owners of points.

In each case, points can be accumulated over multiple purchases of items from the entity or entities. Points are typically assigned in dependence on the amount of money spent and/or the particular items bought. The term “items” as used herein is to be understood as meaning “goods and/or services”. Where the term “product” is used, the term “item should be understood in accordance with this definition. “Services” includes subscriptions. References to an “entity” herein are to be understood as references to an entity or a group of entities using the same customer loyalty programme, unless the context indicates otherwise.

Customer loyalty programmes can be implemented in various ways. Typically a customer registers with the programme, for example by filling in and submitting an online or paper form. Many programmes involve each customer who has registered with the programme being given a customer card having a unique card identifier which is associated with the customer and/or a customer account. Such cards may be known as, for example, loyalty cards, rewards card, points cards, discount cards or club cards. At the PoS terminal, the card identifier can typically be read from a bar code or magnetic stripe, or from a chip located in the card.

In some customer loyalty systems, virtual cards are used with or instead of physical cards. Such virtual cards are stored on a mobile device such as a smartphone that is read by a scanner at the PoS terminal configured to read the phone display

In some customer loyalty schemes, the card holder receives vouchers, for example by post or email, to enable redemption of at least some of the points they have accumulated. The vouchers can be redeemed against items in the entity's stores or reduce a price paid by an amount assigned to the value of the points redeemed.

Online Embodiments

In embodiments of the invention in which the terminals are or include user terminals running a web browser, each user terminal includes a user interface, a processor, a memory and a display. A suitable user interface may be a physical keyboard and cursor control and/or a touch screen, et cetera. The terminal can be, for example, a personal computer or laptop, a tablet computer or other mobile device. The web browser is implemented by suitable computer program code (not shown) stored in the memory (for example a hard disc) which, when executed by the processor, enables a user to interface with the internet in the conventional way.

The server 100 is configured to send the information relating to the game(s) and prize(s) to the user terminals so that the information may be communicated to the user. For example, the game and how to enter may be advertised in a portion of the display. For example, on checkout pages of a website, on which payment is effected for the goods or services selected, or other pages, there may be a virtual PoS with all the same user interfaces and displays for product promotion or game play against redeemed points as might be found at a PoS terminal in a physical store in accordance with embodiments.

Possible Games

In embodiments described below, a game may be entered at a terminal. The game may be a draw. In some of these embodiments, the game is a progressive jackpot draw, although the invention is not limited to such. For example, points may instead be redeemed against entry to another kind of prize or jackpot draw, or to another kind of game. The game is not limited to any particular kind, except it should have an outcome.

In a progressive jackpot gaming system, terminals are linked together to allow users to compete for a common aware or “progressive jackpot”. The jackpot grows rapidly because multiple users are contributing to the jackpot at contemporaneously. The value of the progressive jackpot is incremented by a small amount each time a game is played. When a game is won, the progressive jackpot is awarded to the user obtaining the winning outcome and the jackpot value is reset to a predetermined amount, which may be zero or above.

Game processing software is provided to process entries to games. Each game entry is processed to determine whether a prize is won. The prize may be one of a number of available prizes. For example, a database at a server on which the game processing software runs may include a list of prizes. Examples of possible prizes include: a car; a sum (e.g. £10,000) available weekly; the scanned and purchases in the previous transaction is free—if the purchase is complete, a refund will be given and if the purchase is not complete payment will not be requested at the payment stage; a jackpot; a progressive jackpot; and a particular product.

The software can be configured to randomly or pseudo-randomly determine whether a prize is won, and may weight in favour of winning a particular prize(s) from the list, such as a lower value prize.

Where the prize or one of the prizes is a progressive jackpot, there are various ways that an outcome can be determined by the game processing software and that the progressive jackpot functionality can be implemented. Such ways are known to persons skilled in the art.

For example, a progressive jackpot system may be implemented using a so-called “secret” progressive jackpot. In such a system, the game processing software predetermines a jackpot value and when a game entry causes the progressive jackpot to reach that unknown value the progressive jackpot is won. In such a system, the game processing software, using a random number generator, establishes a jackpot win amount between a maximum and minimum values. A minimum value for the progressive jackpot is also established. At each increment, the controller compares the new jackpot value with the previously established jackpot-win value. If the new value is less that a jackpot-win value, the controller merely updates the jackpot value. When an increment to the current jackpot value causes the value to reach or become equal to the predetermined jackpot-win value, the progressive jackpot is won.

A progressive jackpot system may also be implemented in a manner such that the software determines whether at least one pay off criterion is satisfied. For example, such a criterion may include a predetermined jackpot value being reached, or a certain date and time being passed, or a number of game plays since last resetting of the jackpot being reached. The progressive jackpot can only be one if the at least one pay off criterion is met.

Where a plurality of prizes are provided, the software may provide weighting to make winning of certain prizes more probably than winning of others.

Other ways of implementing a progressive jackpot system are known. For example, implementation of particular progressive jackpot functionality at a server can be understood from US2008/0161105A1 published on 3 Jul. 2008 under the title “Progressive Jackpot Gaming Systems and Methods” in the name of Cadillac Jack, Inc.

Points Redemption System

Embodiments of the invention will now be described wherein the points redemption system is implemented. The purchaser can redeem points against one or more games.

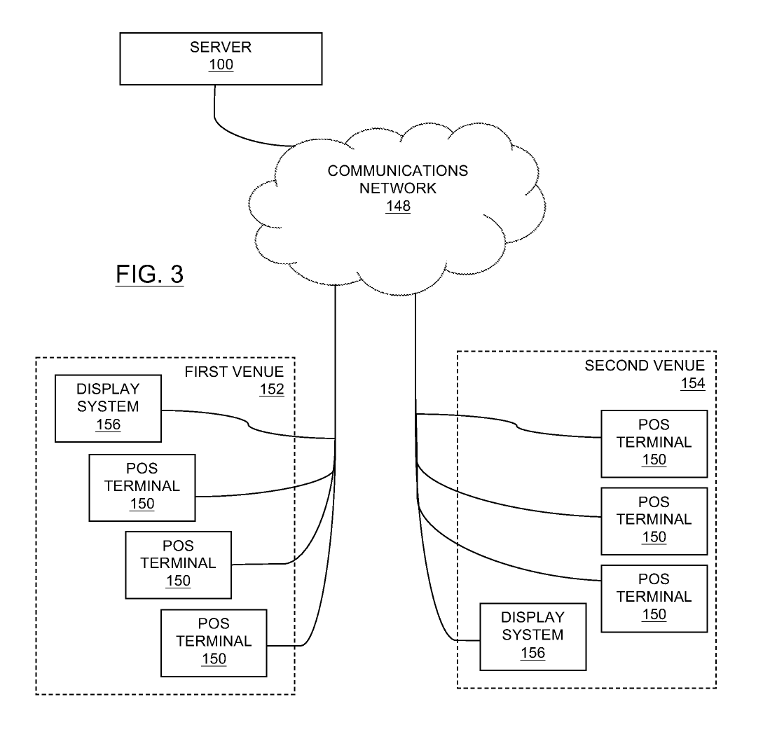

First, apparatus for a points redemption system in which the terminals are PoS terminals is described. Referring to FIG. 3, the points redemption system includes the server 100 connected to electronic point-of-sale (PoS) terminals, indicated at 150 and such as described above, via the communications network 148. The PoS terminals 150 are grouped into a first group 152 and a second group 154.

The first group 152 of PoS terminals 150 and the second group 152 of PoS terminals 150 are located in first and second venues, respectively. At least one display system, indicated at 156, is located in each of the venues and connected to the communications network 148.

The display system 156 is configured to display information under the control of the server 100. The display system 156 receives indications of the current amount of the progressive jackpot from the server 100 and displays the current amount of the progressive jackpot on the screen for people to view. The display system 156 may also receive content from the server 100 to advertise that points can be redeemed against entry to a prize draw.

The functionality of the server 100 includes processing of requests from the PoS terminals 150 to redeem points against entries to the progressive jackpot draw and to communicate with the PoS terminals 150 and the display systems 156.

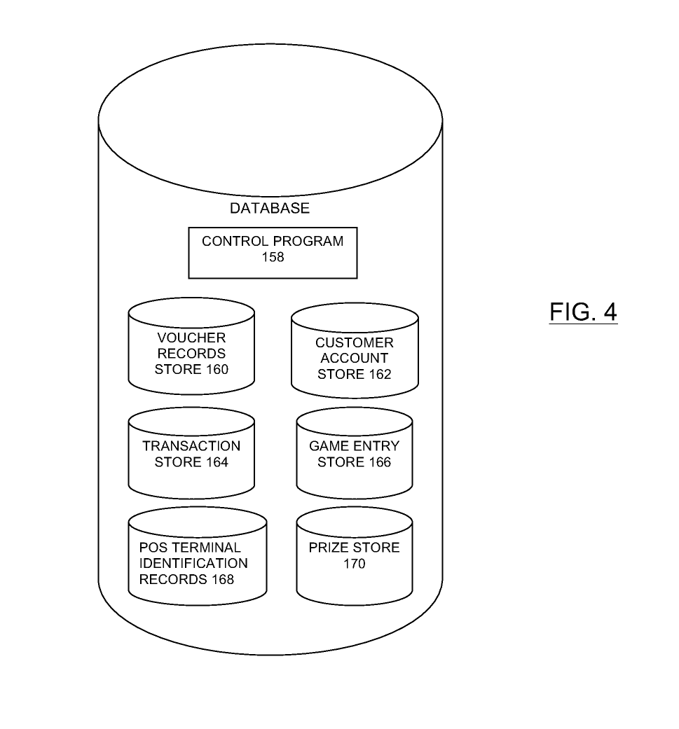

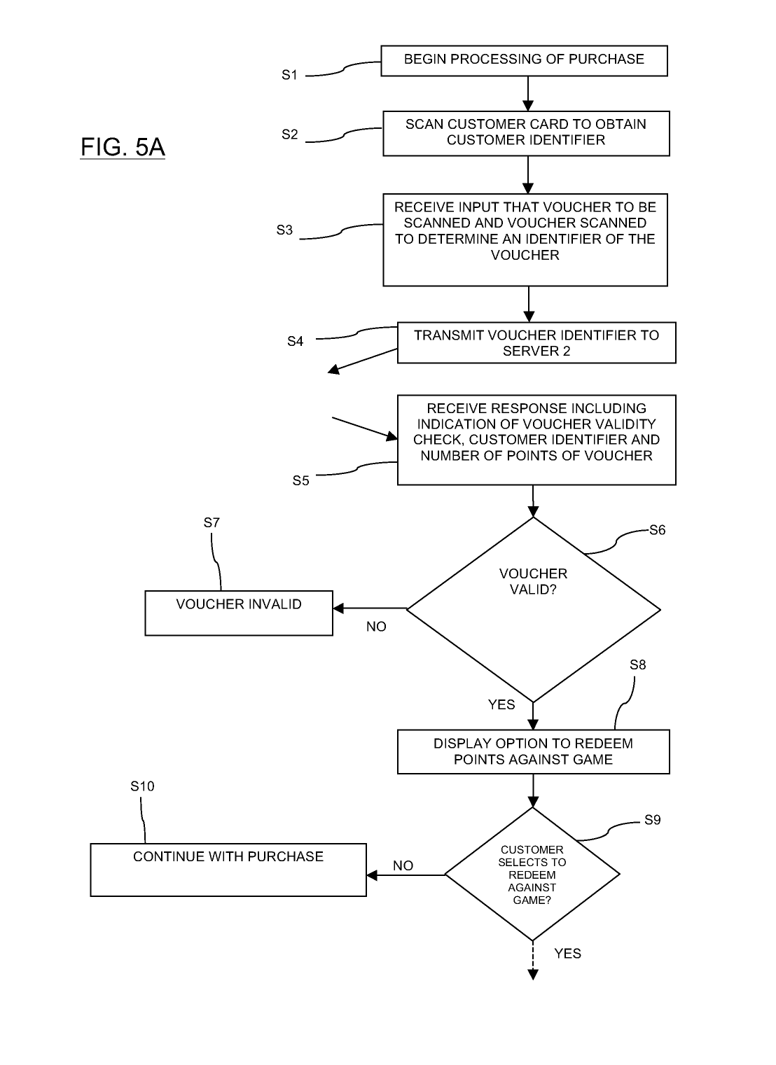

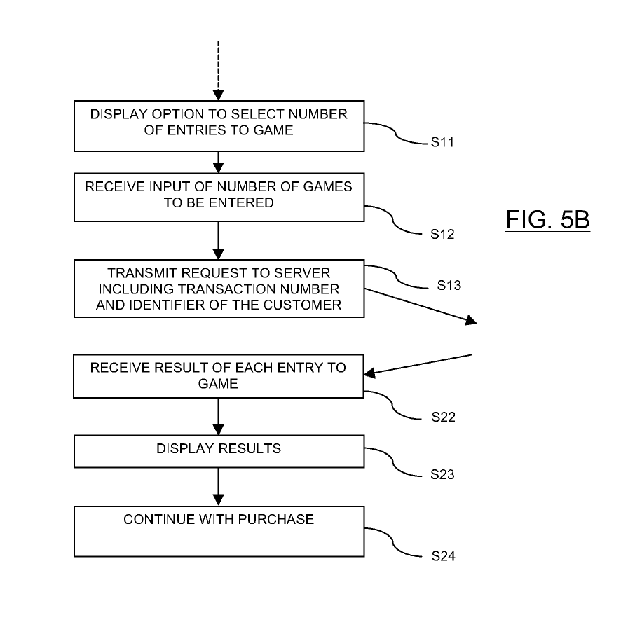

As indicated in FIG. 4, the software and information stored on the storage device 112 include some or all of the following: the control program, indicated at 158, for operating the server 100; a voucher record store 160 for storing information about vouchers; a customer account store 162 for storing information about one or more customers and details of the customer; a transactions store 164 for storing information related to transactions handled by the system; a game entry store 166 for storing information about games entered; PoS terminal identification records 168; and a prize store 170.

The server 100 may be configured to handle in part or wholly the customer loyalty programme. In some embodiments, the customer loyalty programme may be implemented entirely elsewhere in which case, an interface is preferably (but not essentially) provided between the server 100 and other servers on which the programme is implemented. Also, the server 100 may be configured to handle in part or wholly the process of purchasing an item. In this case, a product database is present on the storage device 112 for storing information about products sold by the entity under the control of the server 100.

The voucher record store 160 stores therein at least some of: an identifier of each voucher issued; an expiry date for each voucher; an indication of whether each voucher has been used; optionally, if used, an identifier of the transaction that the voucher was used in; optionally type of product that the voucher can be redeemed against; a number of points associated with the voucher; and an identifier of the customer account for which the voucher was issued.

The game entry store 166 stores a record for each game entered with a game entry identifier, the associated transaction identifier, the number of points redeemed for the game entry, a customer account identifier, a terminal identifier of the terminal from which the request to enter a game(s) was received, and an outcome for each game. Embodiments require less information, but more is desirable for fraud prevention.

The PoS identification records 168 contain a record of an identifier of each PoS terminal 150, together with information on its physical location. This information can be used, together with the information in the game entry store 166, to aid fraud prevention.

In this embodiment, the prize is a progressive jackpot and the prize store includes a value for this prize. The prize value store includes a record of updates to the value of the progressive jackpot. In other embodiments, the prize store lists the prize(s) available to be won.

In this embodiment, a voucher suitable for use in the points redemption system comprises machine-readable data (for example a bar code). The customer may have received the voucher in paper form by post or in an electronic form for printing, for example. Alternatively the voucher may be sent to the purchaser electronically and presented on to the data reader on a mobile device. The machine-readable data includes a unique identifier of the voucher.

Typically, the terms of a points redemption programme allow points to be redeemed only by the customer to whom they were given. Thus, although not essential to the present invention, the points redemption system preferably includes means for preventing fraud. Thus, vouchers are typically used in conjunction with a customer card associated with a particular customer and that customer's customer account. The card includes machine readable data including a unique identifier of the card, for example on a magnetic strip or in a chip. The identity of the customer account to which the voucher was issued can be identified from the voucher identifier using the voucher record store at the server 100. The identity of the customer account associated with the customer card can be identified from the unique card identifier. If the identities of the customer account match, a degree of authentication is achieved. Age verification may be desirable and or necessary and indeed many loyalty cards require the adult age of 18 years as a condition of issue. This may assist in any controls required in some jurisdictions to prevent what may be considered gambling by minors.

Operation of the points redemption system will now be described. A purchaser brings selected items to a PoS terminal 150 and begins the purchasing process (step S1). During the purchasing process, an identifier of the customer account of the purchaser is read from the customer card (not shown) at the PoS terminal 150 in a step S2 using the data reader 144.

The purchaser has an option to redeem vouchers and selects this option at the PoS terminal 150 using the touch screen display 146. The purchaser then scans the voucher using the data reader 144. The PoS terminal 150 thereby receives input of a voucher identifier (step S3).

The PoS terminal 150 then sends at step S4 the voucher identifier, the customer account identifier read from the customer card and the transaction identifier to the server 100. The server 100 determines (step not shown) based on the voucher identifier using the voucher record store 160:
whether voucher is valid, that is, not already used or expired;
the maximum number of points that can be redeemed using the voucher;
optionally a type of item against which the points can be redeemed; and
a customer account identifier.

In addition, the server 100 is configured to maintain a record in the game entry store 166 relating to the outcomes of the games.

The server 100 checks whether the customer account identifier associated with the voucher identifier is the same as the customer account identifier read from the customer card. The server 100 then transmits a message including the determined information and a result of the voucher validity check to the PoS terminal 150 and updates the voucher record store to indicate that the voucher is used with an identification of the transaction identifier. The PoS terminal 150 receives the message at step S5. At step S6, the PoS terminal 150 checks whether the voucher is valid based on the information in the received message. If the voucher is invalid, due to the customer account identifiers not matching or the voucher having already been used or having expired, the PoS terminal 150 indicates such to the purchaser at step S7.

If the voucher is valid, the PoS terminal 150 then displays on the touchscreen display at step S8 to the purchaser an option to redeem some or all of the points against one or more entries to the jackpot draw. The PoS terminal 150 receives input from the purchaser of a selection. If the PoS terminal 150 determines, at step S9, based on input that the purchaser does not wish to take this option, the purchase continues in the conventional way (step S10). If the PoS terminal 150 determines, at step S9, based on input that the purchaser selects to redeem some or all of the points against one or more entries, an option is then displayed on the display requesting the purchaser to select the number of entries (step S11). The user selects to enter one or more games and the PoS terminal 150 receives input from the purchaser of the number of entries at step S12. In alternative implementations, the purchaser can enter games in separate steps, each game being entered after the result of entry of a previous game is known.

The PoS terminal 150 then transmits at step S13 to the server 100 a message including a request for a number of entries to the jackpot draw, the transaction number, the customer account identifier, the identifier of the PoS terminal 14, and the number of points redeemed. The server 100 receives the message generated at step S14, and generates an identifier for each entry and records at step S15 the information in the request in the game entry store 166 alongside the respective game entry identifier.

The server 100 then determines at step S16, for each game entered, whether the purchaser has won the accumulated jackpot using a random or pseudo-random number generator in accordance with techniques known to persons skilled in the art. For each entry for which a “lose” is determined, the server 100, at step S17, adds a predetermined amount of money to the jackpot value in the prize store 170 and updates the game entry database 166 to indicate the result. If at step S19 it is determined that an entry has won the game, the server 100 records the win in the game entry database 166, and resets the value of the jackpot available to win to a predetermined amount, all at step S18.

The PoS terminal 150 receives the message at step S22 and displays at step S23 the result for the purchaser to view. The PoS terminal 150 may display instructions on how to claim the accumulated jackpot. The instructions may be printed on a receipt for the purchaser.

The purchaser then continues with the purchasing process (step S24), paying for the items to be purchased in the conventional way. In other embodiments, purchasing may have to be completed before a game is entered or the result of game/draw may be displayed/printed out only after payment is completed.

It will appreciated by the skilled person that the points redemption system could be designed such that less information is transmitted and retained by the server 100. However, more than the minimum amount of information is preferably retained by the server 100 to guard against fraud.

Optionally, each PoS terminal 150 includes a user interface, for example a touchscreen, separate to the user interface used for the purchasing process. The touchscreen is enables a purchaser to enter a game after the purchasing process is complete. Build up of queues/lines of people waiting to use a PoS terminal to process purchase of items is thus avoided.

The order of some of the steps can be changed. For example, steps S2 and S3 can be reversed. Also, in a simplified alternative embodiment, the customer account need not be identified. Vouchers could simply be redeemed against entry to games. In this case, if a prize was won for an entry, a printout might be provided at the PoS terminal 150, which could be exchanged for the prize won.

In a modification, the purchaser inputs other information to the PoS terminal 150 identifying him or her or enabling identification of the respective customer account. For example, the purchaser may have payment card (for example a credit or debit card) identifying the purchaser, which is read by the PoS terminal 150 during the purchasing process. The server 100 is in this case configured to determine the customer account identifier using the other information. As another example, payment may be made using an appropriately configured mobile device.

In an alternative example embodiment, the purchaser may have a customer card having a unique identification number, which is read by the PoS terminal 150 during the purchasing process. The purchaser has an account with which the customer card is registered and the PoS terminal 150 can communicate with a server, which may be the server 100, having an account store storing the account information, to obtain the identity of the purchaser.

In another example embodiment of the invention, a card may include data storage means which can be read from and written to by an interface at the PoS terminal 150. Instead of a voucher being scanned at step S3, a number of points available for redemption can be read in step S2 together with a customer account identifier. Steps S3 to S7 are omitted.

In the embodiments described, the purchaser is the customer and has a respective customer account. However, a customer may be an entity having a customer account, and one or more persons (purchasers) may have a customer card having a unique identifier associated with the customer account. In this case a purchaser entering a game may be deemed to be playing on behalf of the entity. Alternatively, one or more persons may share a customer account. In these cases, there may be further rules about who may claim prizes.

Additionally or alternatively to selling in stores, points may be acquired by and/or redeemed against online purchase of items, that is, the purchasing process takes place online rather than in a store. An embodiment of the invention will now be described, which can be implemented with or separate from the above described embodiments, in which points can be redeemed online against entry to games.

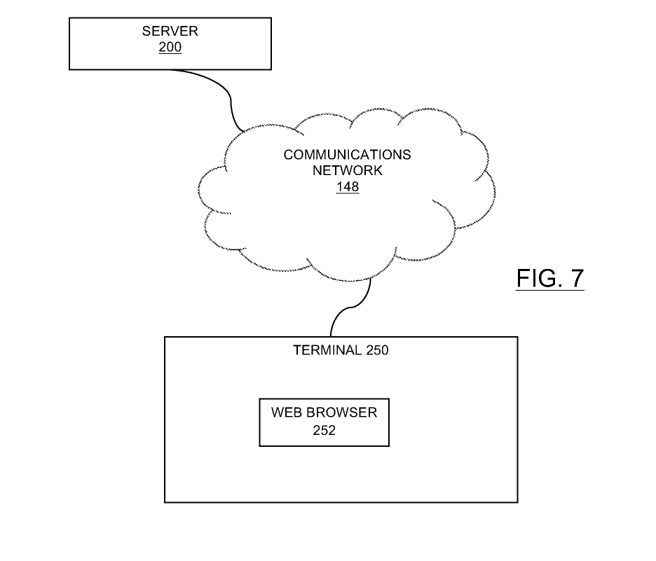

As indicated in FIG. 7, the system includes a user terminal 250 configured for internet access, as has been described above.

The server 100 includes a web server and is configured to enable a purchaser at the user terminal 250 to use points in a customer account and/or to use vouchers against purchase of items. The web browser 252 at the user terminal 250 interfaces with the server 100 for generation of appropriate Internet pages. Static web pages and the web page templates are provided in a static web page and templates store (not shown) associated with the server 100.

Vouchers to be redeemed online typically include a voucher identifier in a form allowing copying, for example alphanumeric. The vouchers can be physical, for example paper, or in an electronic form.

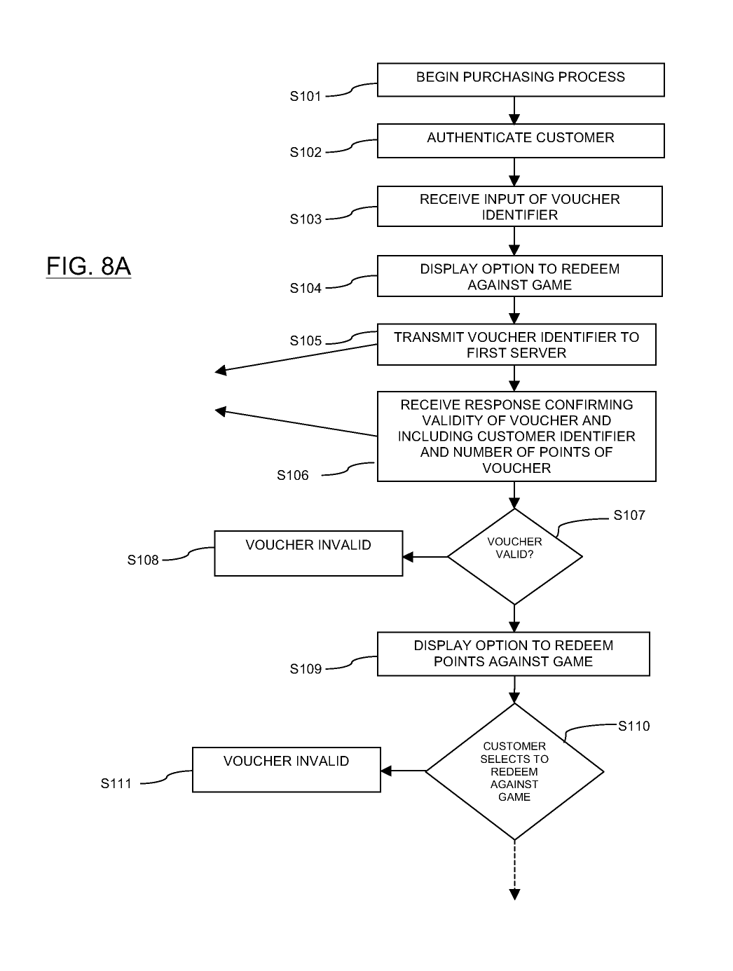

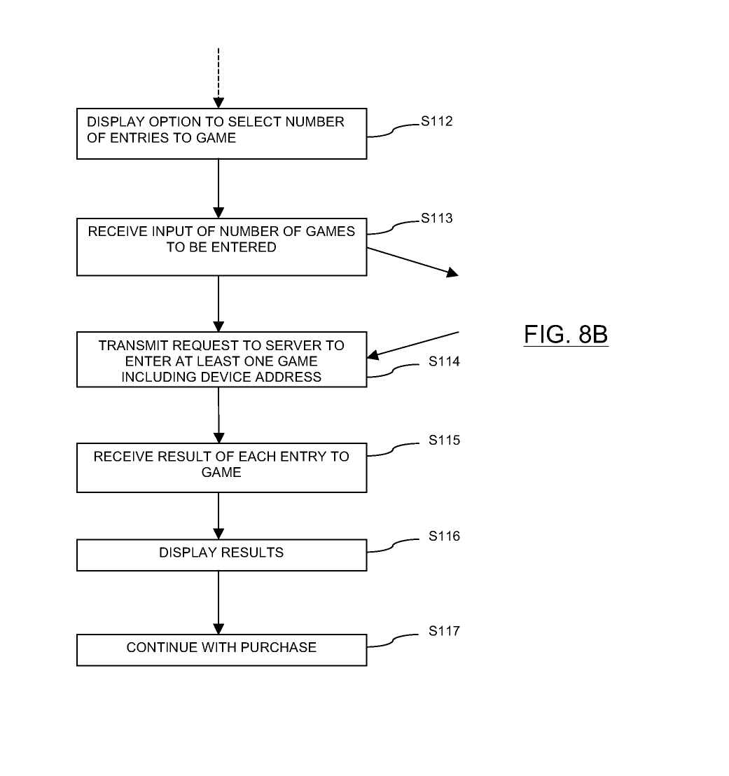

Operation of the points redemption system will now be described, with reference to FIGS. 8A and 8B, which indicate steps that take place at the user terminal 250. The customer has a pre-registered customer account. Initially, the purchaser begins the purchasing process (step S101), that is, selects items to be bought or to redeem points against, and a transaction identifier is generated. Before completing the purchasing process, the purchaser authenticates at step S102 him or herself by entering a login and password. The server 100 or another server is configured to handle authentication of the purchaser for the customer account.

The purchaser then proceeds with the purchasing process. In the purchasing process, the user terminal 250 displays to the purchaser an option to input a voucher identifier. If the purchaser selects the option to enter a voucher, the user terminal 250 receives input of an identifier of the voucher from the purchaser at step S103. If the purchaser does not take this option, the purchase continues in the conventional way.

Where input of a voucher identifier is received from the purchaser at step S104, the user terminal 250 transits the voucher identifier and the transaction identifier to the server 100 in a message at step S105. The server 100 receives the message and determines the number of points that can be redeemed against the voucher. The server 100 also determines whether the voucher is valid using the voucher record store 160 based on the expiry date of the customer account. The server 100 then transmits a response including the determined information to the terminal 250 and, if the voucher is valid, updates the voucher record store 160 to indicate that the voucher is used.

Steps S107 to S114 are respectively the same as steps S6 to S13 and steps S114 to S117 are the same as steps S22 to S24, the user terminal 250 being in place of the PoS terminal 150 and an address of the user terminal 250 replacing the terminal identifier.

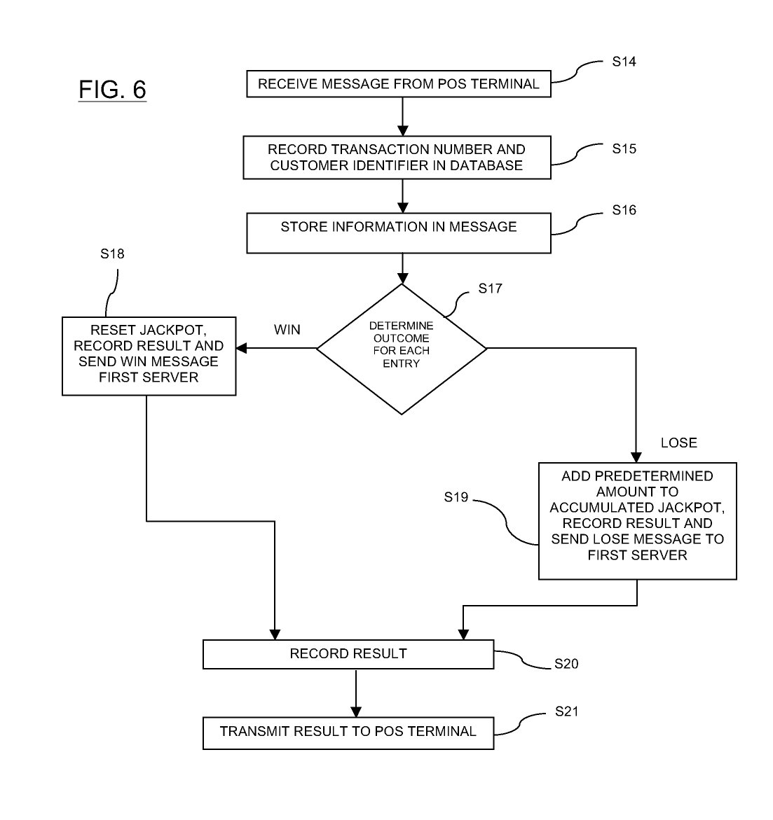

Steps (S14 to S21) at the server 100 are performed as described with reference to FIG. 6.

It will be appreciated that various modifications could be made to the online embodiment described above.

While in the embodiments and modified embodiments described above, the server arrangement is configured to enable entry to a game wherein the possibility exists of winning an accumulated jackpot, it will be appreciated that instead, vouchers or points may be redeemed against play of other kinds of game. For example, a virtual scratch card game may be played with a predetermined prize(s) available to win. Different predetermined amounts of jackpot may be available.

Optionally, the server 100 sends a message to a pre-registered email address of the user of the outcome of the games.

In a modification to the online embodiment described, the purchaser does not enter a voucher, but selects to redeem points in the customer account against entries to games. In this case, the server 100 modifies the balance of points accordingly in the customer account when points are redeemed against a game.

It is envisaged that points are given to customers without charge and cannot be exchanged for cash and can typically only be redeemed in stores operated by one or more predetermined entities. However, if customers are charged for points, it may be necessary to comply with gambling regulations, depending on jurisdiction.

As mentioned above, the server may be a server arrangement comprising more than one server. It may be desirable for the server arrangement to comprise two parts (each being at least one server comprising such hardware as described above in relation to the server) so that a third party can provide and maintain the prize determining functionally. In such case, where the server arrangement comprises first and second servers each having respective control programs and databases/store, the first and second servers communicate with regard to determining whether a game entry wins and with regard to jackpot value. Such communication may include steps as follows: when the first server receives a request for game entry, it sends a message to a second (gaming) server to request processing of a game. The second server receives the message at from the first server and stores in its own game entry database on its respective data storage device a record of the game entry identifiers, the associated customer account identifier and an indication of points redeemed. The second server then processes the game entry to determine whether a progressive jackpot (or other prize) is won. If not won, the second server sends to the first server a lose message including an identifier of the entry and an indication that the entry has not won. The second server also updates the game entry records store to indicate the result and updates the progressive jackpot appropriately. If an entry wins the game, the second server sends a win message to the server 100 including the game entry identifier and an indication that the entry has won, records the win in at its game entry store, and resets the value of the jackpot available to win to a predetermined amount. The first server, in response to its sending of the entry message, receives a response in the form of the win or lose message. In either case, the server records the result in the game entry store and sends a message to the PoS terminal 150, including an indication of the result. Thus, the second server maintains a record of the number of points redeemed. A third party administering the second server may provide the progressive jackpot. The second server preferably determines at intervals a fee due the third party at least in part in dependence on the number of points redeemed against entries to the jackpot.

One or more other parties may own and license rights to the administrator of the second server 8 (the entity, a provider of a customer loyalty programme, or a third party). In this case, the second server 8 preferably determines at intervals a fee due the one or more other parties at least in part in dependence on the number of points redeemed against entries to the jackpot.

Alternative embodiments of the points redemption system will now be described in which the user is provided with a code enabling game entry.

The system can send to the user an electronic communication, for example an email or text message with a code and information on how to enter the game, including for example a website address. The system also stores the code. The user then enters the code at the website corresponding to the address. If the entered code matches the stored code, the server then processes the game entry and sends a notification to the user indicating the outcome.

Operation of exemplary embodiments will be described in the following. It should be understood that the steps may be performed at a server, for example the server 100 of FIG. 1, with a suitably adapted control program. Alternatively, multiple servers can interface to provide the necessary functionality. In particular, performance of the steps may be spread over servers having software running thereon under the control of each of a first entity, such as a retailer, and a second entity, such as a customer loyalty programme operator.

The hardware of FIG. 1 is referred to in the following. Additional and/or optional features and steps will be clear to the skilled person from the description of other embodiments of the points redemption system above.

Embodiments may be performed at a PoS terminal in a physical store, or at a virtual store. In a physical store, the PoS terminal may be self service or assisted.

In embodiments in a physical store, the customer has an option to redeem vouchers at the PoS terminal 150 and selects this option. The purchaser then scans a voucher using the data reader 144. A customer identifier (or a customer account identifier) is also read from a customer loyalty card using the data reader 144. The terminal 150 then sends the customer identifier and identifiers of the voucher(s) to the server 100 together with an indication that the voucher is to be redeemed, at least in part, against entry to a game.

The server 100 receives the voucher identifier and the customer identifier from the PoS terminal 150 and the indication. The server 100 checks that the voucher is valid, as described above, and the maximum number of points that can be redeemed. In response thereto, the server 100 generates and stores a code. The server 100 also causes provision of the code and instructions on how to use the code to enter a game to a customer. This may be done in one or more ways, depending on contact information available, how the system is configured and whether the customer has indicated how he wishes to receive the code. The code and instructions may be sent to the terminal for printing on a ticket or on a receipt where items have been purchased. The server 100 may use the customer identifier to retrieve information from a customer information store enabling electronic contacting of the customer, for example a telephone number enabling notification by text message or an email address, and send the code and the instructions to the customer accordingly. The instructions preferably comprise at least a website address at which the code can be entered and a game can be played.

When the code has been sent, the server 100 updates the customer information database to indicate that the voucher has been redeemed.

The customer then accesses a website at which the code can be entered on a device using a web browser. The device may be any device allowing internet access for example a desktop computer, laptop, pda, tablet, or other mobile device. The website may be operated by the store owner, or by a customer loyalty programme operator. Alternatively, an application may be provided that runs on the device to interface with the server.

The server 100 (or alternatively another one or more servers responsible for game entry) receives the code from the device. The server 100 compares the code received from the device with stored codes. When a match is found, the server 100 processes the game to determine whether the customer has won a prize. The prize may be in accordance with the description of possible prizes above, for example a prize selected from a list of prizes, a jackpot draw, or a progressive jackpot draw.

The server 100 records an outcome of the game in the customer information database at least if the outcome is a win. Of course in an alternative embodiment where another server handles game entry, the outcome may be stored elsewhere. Where the prize is a progressive jackpot, an accumulator may be incremented if the outcome is a lose.

The server 100 then sends a notification of an outcome of the game to the device for communication to the customer. Alternatively, the customer may be notified by text message or email where those details can be retrieved from the customer information database by the server 100. The notification may include instructions on how to claim a prize if a prize is won.

The device may be in the form of an internet connected terminal located in a store. Thus, the customer can go straight from a PoS terminal to the device in order to enter a game(s). The customer can input the code received by text or printed or a ticket or receipt, or check his or her email to retrieve the code and then input the code at the game entry website.

In an alternative, the vouchers may be redeemed without need for a customer loyalty card to be scanned. The identity of the customer to whom the vouchers have been issued may be stored in a customer information database in association with voucher identifiers. In this case, the identity of the customer and information enabling electronic contacting of the customer are stored in the customer information database. The server can retrieve the contacting information from the database and use the contacting information to send the code to the customer. This advantageously means that only the customer to whom the vouchers were issued may receive the opportunity to enter a game in response to redemption of the vouchers.

In an alternative, the customer identifier is obtained from or by virtue of the customer's credit card.

It should be noted that implementation is not limited to large stores. Small retail stores or chains of such stores (or cafes, restaurants, etc) may implement the system using their own customer loyalty programme, or a collaborative one.

In embodiments, the user of the device may be authenticated as the customer prior to game entry. This may be done using the customer identifier or other information in the database, the user being required to submit corresponding information. In online embodiments, the user may be asked to login using a shared secret password for authentication.

The points redemption system may be advertised on display systems 156, as described above.

The customer may be able to opt out of the system at a website, preferably the website associated with the customer loyalty card/account. Thus, when redeeming vouchers, the terminal would not provide an option for the customer to redeem points against entry to game(s).

In online embodiments, the website of the virtual store may include a link to the website at which the code can be input and the game played in order to facilitate access.

The code may enable several game entries, depending on the value of the vouchers/number of points redeemed.

Embodiments of the points redemption system result in various advantages. Game entry provides entertainment. The possibility of winning a prize provides excitement, as may winning a prize. The possibility of winning an enormous progressive jackpot provides an in-store attraction.

Where the prize is a progressive jackpot, very large jackpot prizes may become available, in dependence on how the probability of winning is configured. This is due to the linking together of many (thousands) of checkouts located in multiple stores allowing for the pooling of millions of ‘game’ plays and all automatically at checkouts.

The points redemption system may be configured in stores to allow game entry at self-service checkout terminals and not terminals with a checkout assistance, thereby to encourage shoppers to use self-service checkouts, thereby saving the store on salary cost.

The points redemption system may encourage customer loyalty. Customer may thus visit a store implementing the points redemption system more frequently.

The points redemption system may bring publicity to a store chain, both at launch and also ongoing publicity at each time a progressive jackpot is won.

By redeeming points on game entry, customers do not redeem their vouchers against other items, thereby saving stores money.

Product Promotion System

Other embodiments of the invention relate to a product promotion system. The product promotion system can be (but is not necessarily) implemented independently of a customer loyalty system and is described as such. In embodiments, the product promotion system may be implemented for use by a purchaser at a PoS terminal in a store, and/or at a user terminal in association with online item purchase. The implementation for use by a purchaser at a PoS terminal is described first.

The PoS terminal is configured to determine in dependence on an item identifier whether purchase of the item includes an entry to a game such as described above. The PoS terminal may communicate with a server arrangement, which may process the game entry, and receive an outcome of the game from the server arrangement.

The product promotion system includes an administration terminal to allow an item promoter to arrange a promotion for an item. Advertising of the item and of the possibility of winning a prize by purchasing the item would take place on display systems in the first and second venues. The item promoter may be the manufacturer of the item.

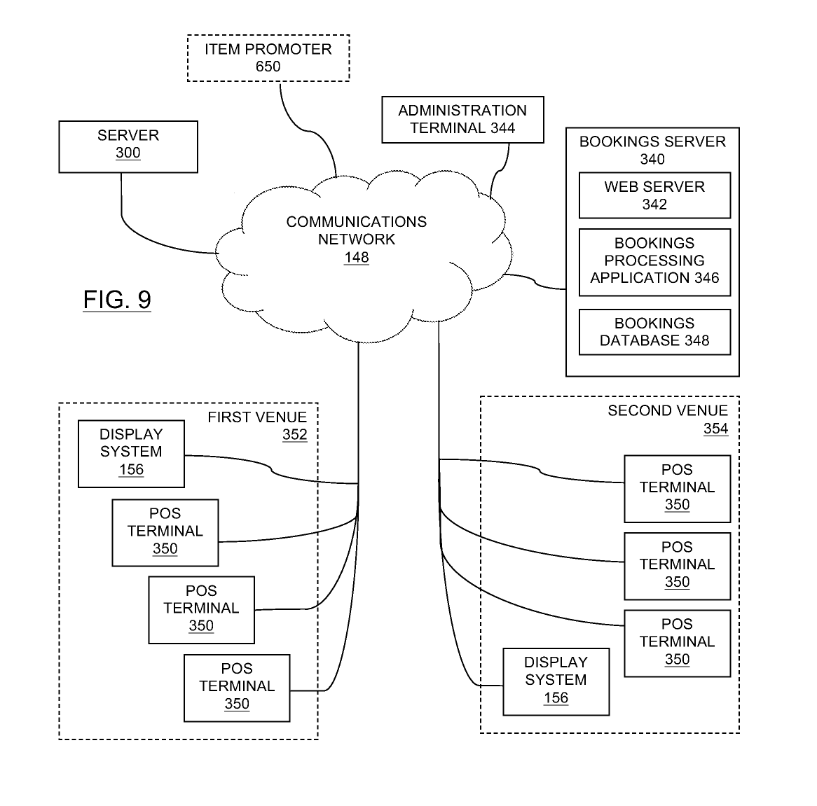

Referring to FIG. 9, the product promotion system includes the server arrangement in the form of a server 300 connected to the communications network 13. Electronic point-of-sale (PoS) terminals 350 and display systems 156 are connected to the communications network 148. The PoS terminals 350 are grouped into a first group 352 and a second group 354. The first group 352 of PoS terminals 350 and the second group 354 of PoS terminals 350 are located in first and second venues, respectively. For example, the PoS terminals in one group may be located in a store belonging to an entity and the PoS terminals in another group may be located in another store belonging to the same entity or another entity using the same customer loyalty programme. The embodiments are not limited to any particular number or groups or venues. The venues are of a first entity and may, for example, be retail stores such as supermarkets. A venue may only have a single PoS terminal, for example, if the store is small. At least one display system 156, as described above is located in each of the venues and connected to the communications network 148. In other embodiments, display systems may be absent. The server 300 is configured to process requests to enter games and to communicate with the PoS terminals 350.

A bookings server 340, including a web server 342, and the administration terminal 344, including a web browser, are connected to the communications network 148. The administration terminal 344 may be any kind of terminal running a web browser to provide internet access to an item promoter. Although only a single administrator terminal 344 is shown, an item promoter would typically be able to arrange item promotion at any internet connected terminal running a web browser. In another embodiment, a dedicated software application is installed on the administrator terminal and interfaces with the bookings control application. In this case the item promoter can arrange item promotion using this software application. In this case the item promoter can arrange item promotion using this software application on the bookings server 340. Generally, the administration terminal 344 allows an item promoter to arrange a promotion for an item. Advertising of items under promotion and of the possibility of winning a prize by purchasing the item takes place on display systems in the first and second venues.

The bookings server 340 is configured to enable the item promoter to arrange item promotion. A web browser at the administration terminal 344 interfaces with the bookings server 340 for generation of appropriate Internet pages at the administration terminal 344. Static web pages and the web page templates are provided in a static web page and templates store (not shown) associated with the web server 342.

The bookings server 340 includes a bookings processing application 346 and a bookings database 348. The bookings processing application 346 is implemented by suitable computer program code (not shown) stored in a suitable storage medium (for example a hard disc) and which, when executed by suitable processing apparatus (not shown), causes bookings server 340 to provide the functionality described herein. The bookings processing application 346 can be a single processing apparatus or a number of networked processing apparatuses networked by any conventional communications network. The bookings processing application can comprise a single module or a number of modules.

The bookings database 348 contains information on promotions, for example and not limited to, dates and times of promotions, items to be promoted, stores in which promotions are to take place, content relating to advertising of the promotion, information identifying the item promoter, authentication information for authenticating item promoters, number of purchases after which promotion expires.

An item promoter can make reservations on the bookings server 340 using the administration terminal 344 for the promotion of one or more items over particular time periods. This involves the item promoter inputting information regarding the promotion. This typically involve checking availability of time slots over which advertising for an item can be displayed on the display system. The item promoter then inputs dates of the promotion and the item(s) to be promoted. Optionally, the item promoter may select stores to be targeted based on particular characteristics of the stores. For example the item promoter may select to target stores in a particular region(s), specific stores, out-of-town stores, stores associated with petrol (gas) stations, stores having a particular department such as a clothing department, et cetera. Optionally, the administrator may select particular days of week in which promotion is to take place. Optionally, over the period(s) selected for promotion, the item promoter may select hours of day in which promotion is to take place. The item promoter will typically be a manufacturer or distributor of a product or an associated company. It will be understood that the item promoter and retailer operating the store are separate organisations. Typically, the retailer sells products of the item promoter.

The item promoter may also be able to stipulate that promotional content will be displayed on display systems on particular aisles in stores, and/or at entrances to aisles. It will be appreciated that there are many criteria relating to a promotion that the item promoter may select or input.

The item promoter may upload content to the bookings server 340 using the administration terminal 344. The content is for display on the display systems 156 over the reserved periods. The content may include graphics, video and/or audio. The bookings server 340 may include a template into which the content can be inserted. The item promoter may also upload content for display on PoS terminals 356 during purchase and game entry.

The data input by the item promoter is recorded in the bookings database 348 at the bookings server 356. The bookings server 340 controls the display systems in dependence on the data in the bookings database. Alternatively, the server 300 may control the display systems, in dependence on data in the bookings database. The bookings server 340 also sends updates to the PoS terminal 350 such that each PoS terminal 350 has a stored up-to-date list of the items being promoted. In alternative embodiments, in which the server 300 holds such a list and determines whether purchased items are under promotion, the booking server provides updates to the server 300.

The bookings database 348 preferably also includes a statistical information store for information relating to a particular promotion. The item promoter may then view data relating to the promotion to assess the success of the promotion. The data may include one, some of all of the following: number of sales, number of sales over particular time periods, comparison of sales over the promotion period with sales over a non-promotion period, sales by kind of prize offered; any or all the aforesaid information by store or region, information on types of shopper who have bought a product (the types being prescribed by the customer loyalty system), information on shopper behaviour in response to promotions. This allows item promoters to build up information so that criteria of future promotions can be set for good benefit from a promotion. It allows item promoters to determine the value of the product promotion system. The data may be viewed substantially in real time. The item promoter may be able to access information on the prizes that have been won in real-time.

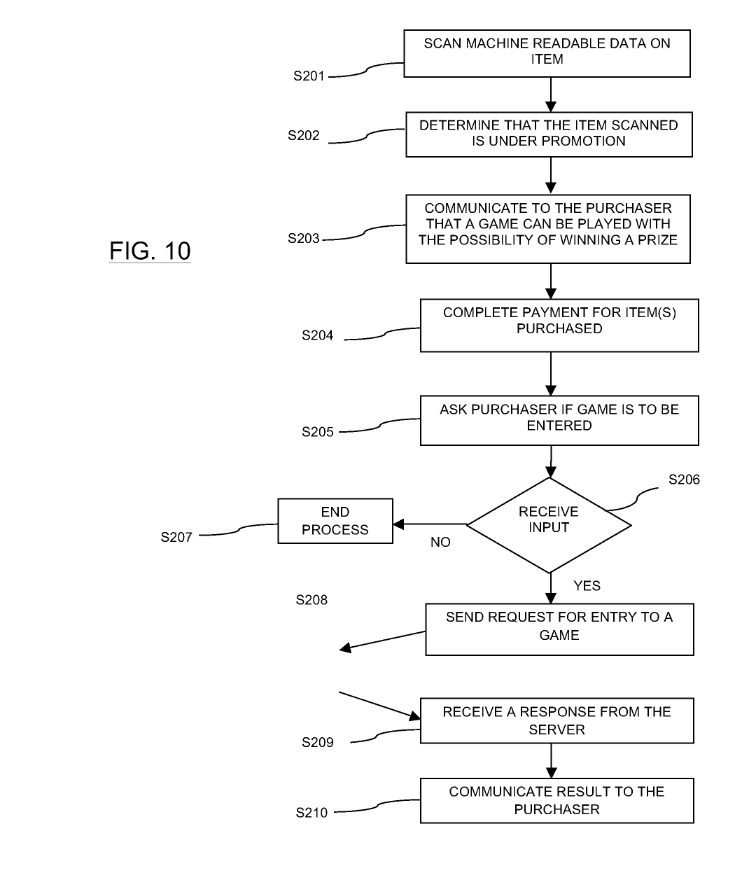

The PoS terminal 350 is configured to determine when an item whose item identifier has been read by the terminal 350 is under promotion by checking against the list of items under promotion. Referring to FIG. 10, steps in the game entry process are now described. The PoS terminal 350 is a self-service PoS terminal, although in other embodiments a checkout assistant may be between the customer and the PoS terminal 350. First, at step S201, the customer scans the machine readable data (e.g. barcode) on an item for which a promotion is in place during the purchasing process. At step S202, the PoS terminal 350 determines, using the stored list, that the item scanned is an item being promoted. In response to the determination, the PoS terminal 350 then communicates to the customer in step S203 that, after payment has been received, a game can be played with the possibility of winning a prize.

The customer completes payment in step S204. The PoS terminal 350 then communicates in step S205 a request to the customer for confirmation that a game is to be entered relating to the promoted item purchased. The customer, using the user interface, for example in the form of a touchscreen display, at the PoS terminal, either accepts or declines (or takes no action, which is deemed to be declining) at step S206. If the customer declines, the PoS terminal 350 ends the game entry process (step S207). If the customer indicates that a game is to be entered, the PoS terminal 350 transmits at step S208 a request to the server 350 for entry to a game. The request includes a terminal identifier, an indication that a game is to be entered and a transaction identifier. Where the purchaser is a registered customer having a customer loyalty card, a customer account identifier from the card is also transmitted. The request may include further information, for example the identity of the item promoted that has been purchased.

The server 300 then perform the steps S14 to S21 described above. At step 15, the server 300 may additionally determine using an item identifier of an item under promotion an identifier for the item promoter and/or a code for the promotion, and store the additional information in the game entry store 166. The PoS terminal 350 receives a response from the server 300 at step S209 and communicates the result to the customer at step S210 by means of the touchscreen display. If the result is that the customer has won a prize, the PoS terminal 350 may display instructions on how to claim the prize. The instructions may be printed on a receipt for the purchaser with instructions on how to claim a prize.

It will be appreciated by the person skilled in the art that, rather than items to be purchased having machine readable item identifiers affixed to them and the identifiers being read by a PoS terminal, the items could have RFID tags attached thereto. In this case, the server controlling the tag system would detect when a promoted item has been paid for and enable a purchaser to enter a game in the manner described above.

Additionally or alternatively to in stores, the product promotion system may be implemented for online advertising and purchasing. The purchasing process takes place online rather than in a store. Another embodiment of the invention will now be described.

The item promoter may reserve at the booking server 340 using the administration terminal 344 for an item to be promoted over particular time periods, as described above. The item promoter may upload content, as described above.

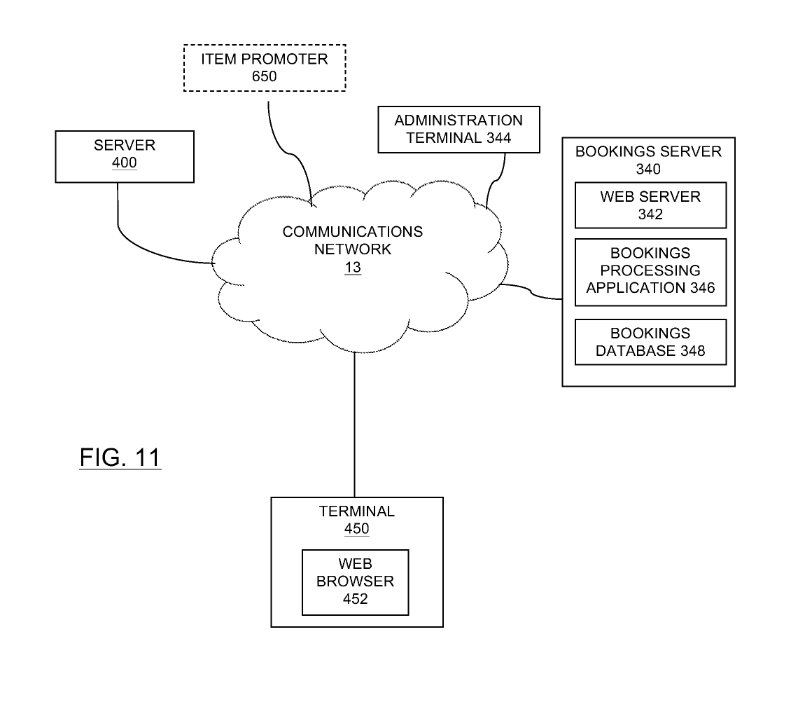

Referring to FIG. 11, online product promotion system includes the servers 300, administration terminal 344 and bookings server 340, each as already described and connected to the communications network 148. It should be understood that server 400 is the same as server 300, but modified for online product promotion, additionally or alternatively. The system also includes a user terminal 450 connected to the communications network 148, at which a purchaser can purchase items via an entity's website. Promoted items may be advertised on the entity's website over a period(s) reserved by the item promoter. The item promoter may upload content to the bookings server for such advertising.

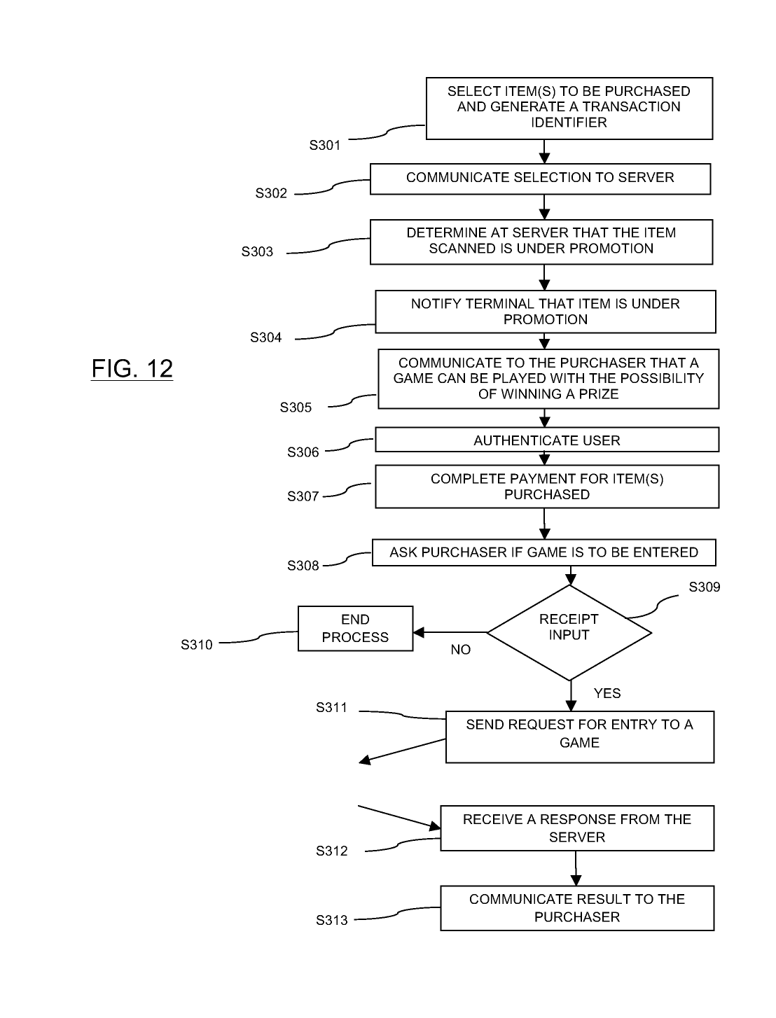

Operation of the prize promotion system will now be described, with reference to FIG. 12, which indicate steps that take place. Initially, the purchaser begins the purchasing process (step S301), that is, selects using the user interface items to be bought or to redeem points against, and a transaction identifier is generated. On selection of each item, the terminal communicates the selection to the server 400 at step S302. The server 400 checks on a list thereat whether the item is under promotion at step S303. When an item is selected that is under promotion, the server 400 sends a message to the terminal 450 indicating this (step S304). The user terminal 450 receives the message at step S305 and communicates that this to the purchaser, for example, by display of suitable text on the terminal's screen.

Although not essential, the purchaser preferably has a pre-registered customer account. Before completing the purchasing process, the purchaser authenticates at step S306 him or herself, for example by entering a login and password, although authentication in other ways is possible. The server 400 or another server is configured to handle authentication of the purchaser for the customer account. Alternatively, the purchaser can authenticate him or herself before or between selection of items to be purchased.

The customer completes payment in step S307. The user terminal 450 then communicates in step S308 a request to the customer for confirmation that a game is to be entered relating to the promoted item purchased. The customer, using the user interface, either provides confirmation or declines (or takes no action, which is deemed to be declining) at step S309. If the customer declines, the terminal 450 ends the game entry process (step 310). If the customer indicates that a game is to be entered, the user terminal 450 transmits at step S311 a request to the server 300 for entry to a game. The request includes a terminal identifier, an indication that a game is to be entered and a transaction identifier. The request may include further information, as described above in relation to the embodiments in stores.

The server 400 then performs the steps S14 to S21 described above. The terminal 314 receives a response from the server 400 at step S312 and communicates the result to the customer at step S313 by means of the touchscreen display. If the result is that the customer has won a prize, the terminal 450 may display instructions on how to claim the prize. Alternatively, provided the purchaser has entered an email address or is a registered customer, where an email address is stored at the first server corresponding to the customer account, the server 400 sends an email to the purchaser with instructions on how to claim the prize.

Alternative embodiments of the product promotion system will now be described in which the user is provided with a code enabling game entry. After a customer has bought a promoted product, the system can send to the user an electronic communication, for example an email or text message. On entering the code, the customer enters or is given the option of entering a game in which the customer may win a prize.

First, embodiments in a store are described in relation to a system having the same hardware as the system previously described with reference to FIG. 9. In addition, the item promoter server 650, indicated with dashed lines, is provided in the present embodiments. In this embodiment the control program is configured to allow the server to carry out the steps to be described, including to process data received from the PoS terminals 102, to cause a message including a code for the user to be generated and sent, and the code also to be sent to the item promoter server 650.

It may be noted that the server 300 may be configured to handle in part or wholly the customer loyalty programme. In some embodiments, the customer loyalty programme may be implemented entirely elsewhere in which case, an interface is preferably provided between the server 300 and other servers on which the programme is implemented to enable the server 300 to have the data necessary to function. Also, the server 300 may be configured to handle in part or wholly the process of purchasing an item. In this case, a stock control database is present on the server 300 for storing information about products sold by the entity under the control of the server 300.

Operation of embodiments of the product promotion system will now be described. The item promoter server 650 has like hardware components to the server 300, as indicated above, or may be modified as will be clear to the skilled person. The item promoter server 650 includes software under the control of the item promoter.

The server 300, interfacing with the bookings server, periodically provides each PoS terminal 350 with a list of products that are under promotion and parameters associated with their promotion, for example a start date and time for the promotion of each product and an end date and time. The PoS terminal 350 is configured to determine when an item whose item identifier has been read by the terminal 350 is under promotion by checking against the list. Alternatively, the server 300 can determine whether an item is under promotion in a similar way.

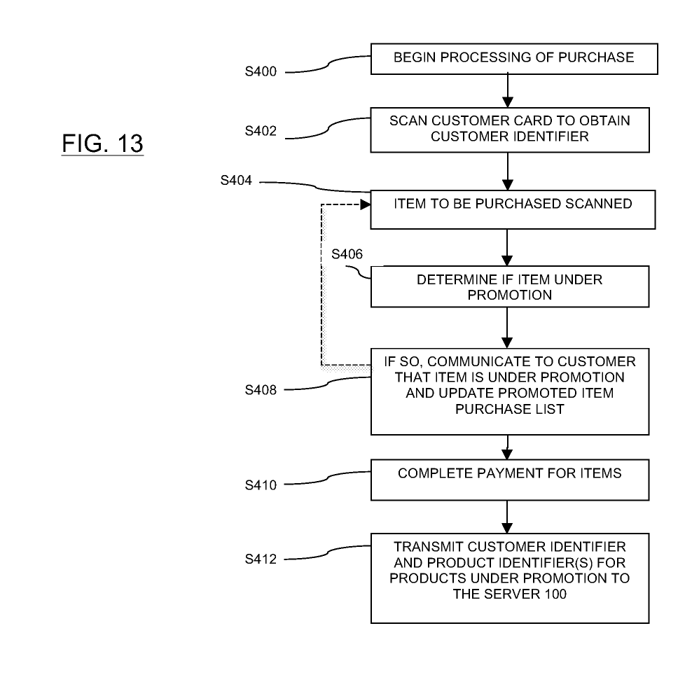

With reference to FIG. 13, a customer brings selected items to a PoS terminal 350 and begins the purchasing process (step S400). During the purchasing process, an identifier of the customer account of the customer is read from the customer card (not shown) at the PoS terminal 350 in a step S402 using the data reader.

At step S404, the customer scans the machine readable data (e.g. barcode) on a product for which a promotion is in place during the purchasing process. At step S406, the PoS terminal 350 determines, using the stored list, if the item scanned is an item being promoted. In response to a determination that the item is under promotion, the PoS terminal 350 stores the item identifier in a temporary promoted item purchase list for that transaction at step S408. At optional step S408, the PoS terminal 350 communicates to the customer that the customer will receive a text message and/or email with instructions on how to enter a game with the possibility of winning a prize. The customer may then scan the machine readable data on another item, in which case the process returns to step S404. Otherwise the process continues to step S410.

The customer completes payment in step S410. The PoS terminal 350 sends in step S412 a message containing an identifier of the customer and the promoted item purchase list to the server 400.

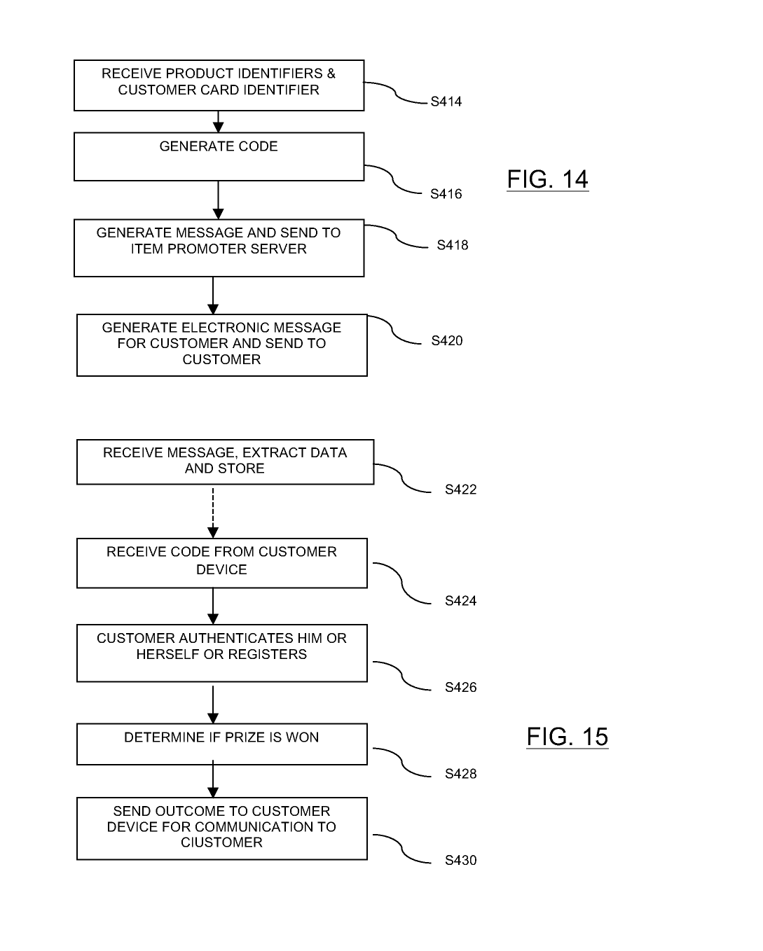

Referring to FIG. 14, the server 300 receives the message at step S414. In response to receiving the message, the server 300 extracts the promoted item purchase list and the customer account identifier, and generates a code at step S416.

At step S418 the server 300 sends a message to the item promoter server 650 containing an identifier of the customer, the promoted item purchase list for the transaction at least to the extent that it relates to the products promoted by the item promoter, and optionally information on other purchases made by the customer, in particular purchases of the item promoter's non-promoted products. The message may contain further information, such as details for electronically contacting the customer.

At step S420 the server 300 then sends that code to the customer by electronic communication, for example by email using an email address of the customer or by text message using a pre-stored telephone number. The code may be single use. The contact details of the customer may be stored in the databases of the customer loyalty system used by the store, or in databases of a third party customer loyalty system where such a system is used, and the customer has registered their contact details with the customer loyalty system. In an alternative embodiment, the code is sent to the PoS terminal 350 and is printed, either on a receipt for the transaction or separately.

Referring to FIG. 15, the item promoter server 650 receives the message at step S422, extracts the contents of the message, and stores the information contained in the message, in a customer information database. The customer information database may already have a record of the customer, in which case the purchasing history of the customer is updated, or a new record may be created.

The customer receives the email or text message, which includes the code, the address of a webpage, and preferably information on at least one game that can be entered at the website. The customer then accesses the webpage and enters the code in order to enter a game. The webpage can be accessed at any device having a web browser, for example an appropriately configured mobile device or a personal computer or tablet or pda.

The item promoter server 650 receives the code from the device at step S424. The item promoter server 650 compares the code received from the customer with codes received from the server 300 to find a match. If a match is found, the item promoter server 650 records the code as used in the database and then processes a game entry. The item promoter server 650 determines whether the customer has won a prize at step S428.

At optional step S426, the person who controls the device and inputs the code is authenticated as the customer. The item promoter server 650 includes authentication functionality to this end. Authentication can be achieved in various ways. The person may be requested to enter into a field in a web browser information for use in authentication. Where the item promoter has a record of the identity of the customer, for example because it has received identification information from the first server 300 or because the customer has pre-registered with the item promoter, the item promoter can request identification information corresponding to that in of the record. Such information may be in the form of an email address. Where the customer is pre-registered, a shared password may be entered. Where the item promoter does not have information on the customer, it may request that the customer register, thereby enabling capture of customer information. In this case, the code entered enables purchasing information received with the code from the first server 300 to be linked to the captured customer information, so that a purchasing history record for the customer can be created. In embodiments, the customer is not authenticated.

The game is not limited to any particular kind, except it should have an outcome. It may be any of the games mentioned above. Game processing software is provided to process entries to games. Each game entry is processed to determine whether a prize is won. The prize may be one of a number of available prizes. For example, a database at a server on which the game processing software runs (which may be the item promoter server 650 or another connected server 300) may include a list of prizes.

The software can be configured to randomly or pseudo-randomly determine whether a prize is won. Where a plurality of prizes are provided, the software may provide rules such as weightings to make winning of certain prizes more probable than winning of others. The rules may weight in favour of customers in dependence on those customer's purchasing history, for example if the history indicates that they often buy products of the item promoter. The game entry may take one or more of a number of forms. For example, a virtual scratch card game may chosen to be played with a predetermined prize(s) available for win. The number of entries to games allowed for a particular code may depend on the number of products purchased and/or their value and/or the particular products bought and/or on other criteria. More than one code may be sent to a customer allowing entry to a game, depending on any of the same criteria.

The item promoter server 650 sends information indicative of the outcome to the device at step S430 for communication to the customer. If the outcome is a win, the information includes instructions on how to claim the prize.

In an alternative embodiment, in step S422, the server 300 does not generate the code, the message that the server 300 sends to the item promoter server 414 does not therefore include the code, and the server 300 does not cause a text message or email to be sent to the customer. Instead, these steps are performed by the item promoter server 650. Thus, the item promoter server 650 receives a message from the server 300, which includes at least an identifier of the customer, and an indication that the customer has bought one of the item promoter's products. Preferably, the message includes an indication of the products being promoted by the item promoter that the customer has bought and the amount of each product bought. The message may also contain electronic contact information of the customer. Additionally or alternatively, the item promoter server 650 may be configured to retrieve customer contact information from a data store using the customer identifier. In response to receiving the message, the item promoter server 650 extracts and stores said information in the database and causes an electronic message, for example an email or text message to be sent to the customer, the message being like the message at step S424.

The customer may be pre-registered with the item promoter and/or the first entity. Where the product promotion system is provided by a third party, the customer can be pre-registered with the third party. Pre-registration enables at least one of the item promoter, third part or first entity to have contact information of the customer.

In embodiments in which the customer is pre-registered with the retailer, or a third party, the retailer or the third party may provide authentication functionality on the item promoter's website or otherwise facilitate authentication.

The one or more entities with which the customer is registered may cause to be displayed to the customer, during registration or subsequently, an option to opt-in or opt-out of the product promotion system. Thus if the customer opts out, when the customer buys products that are under promotion, the customer will not receive an electronic communication or a printout of a code. In addition, if the customer opts out, details of the customer will not be passed to the item promoter.

It should be noted that, in embodiments, the product promoted system can function without passing details of the customer, including any identifier of the customer or contact details of the customer to the item promoter. The message sent in step S418 can contain the code and information on the products purchased. When the customer enters the code on the item promoter's website, if the customer is not pre-registered, the item promoter can request that the customer register with the item promoter and input contact information. This can be a useful way for the item promoter to capture customer contact information. The item promoter can then associate that customer with the products that the customer has purchased using the code. If the customer is pre-registered, the customer enters the code and also identifies/authenticates himself, and the item promoter can then associate the customer and the products purchased by matching the received code and updating the purchase history of the customer appropriately. The purchases of the customer can then be tracked and the item promoted can market to the customer appropriately.

Each code may be associated with a particular promotion to enable tracking of the amount of codes redeemed for each promotion. This enables the item promoter to assess the benefit of a promotion.

It will be appreciated by the person skilled in the art that, rather than items to be purchased having machine readable item identifiers affixed to them and the identifiers being read by a PoS terminal, the items could have RFID tags attached thereto. In this case, the server controlling the tag system would detect when a promoted item has been paid for and perform subsequent steps in the process accordingly.

In a modification, rather than a list of promoted items being stored at each PoS terminal 350, the list can be stored at the server 300. Each time that a product identifier is input, the PoS terminal 350 communicates an identifier of the product to the server 300. The server 300 then determines whether the product is under promotion by checking against the list. When an item is determined to be under promotion, the server 100 sends a message to the terminal 350 indicating this (step S304). The PoS terminal 350 receives the message and communicates that the product is under promotion to the customer, for example, by display of suitable text on the terminal's screen.

In a modification, the customer inputs other information to the PoS terminal 350 identifying him or her or enabling identification of the respective customer account. For example, the customer may have payment card (for example a credit or debit card) identifying the customer thereon, which is read by the PoS terminal 350 during the purchasing process. The server 300 is in this case configured to determine the customer account identifier using the other information. As another example, payment may be made using an appropriately configured mobile device.

Additionally or alternatively to in physical stores, the product promotion system may be using codes to enable game entry in online embodiments wherein purchases are made from online stores. This may be implemented by enabling purchasing and/or game play using a web browser, but may alternatively be implemented in an application running on a device. Another embodiment of the invention will now be described wherein purchasing and game play are implemented using a web browser.

The system may be implemented with the same hardware as shown in FIG. 11, except additionally with the item promoter server 650 which has already been described. The system also includes a server 400, which is similar to the server 300, but modified for online product promotion, additionally or alternatively. Promoted items may be advertised on the entity's website over a period(s) reserved by the item promoter. The item promoter may upload content to the bookings server for such advertising. The web pages preferably indicate whether products available for purchase are under promotion.

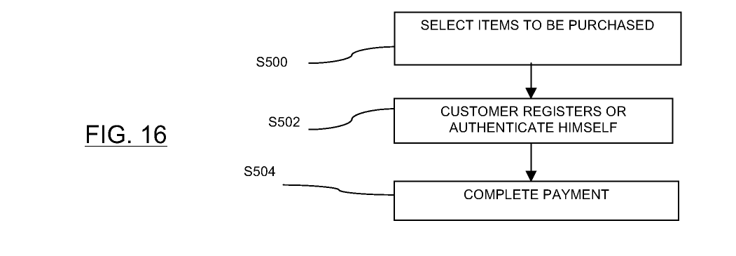

Operation of the product promotion system will now be described, with reference to FIG. 16, which indicate steps that take place at the user terminal 450. Initially, the customer begins the purchasing process (step S500), that is, selects items to be bought. Each time a product is selected for purchase, the terminal 450 sends a message indicating such to the server 400. The server 400 creates a list of products under promotion that the customer is purchasing. Before completing the purchasing process, the customer authenticates at step S502 him or herself by entering a login and password. The server 400 or another server is configured to handle authentication of the customer for the customer account.

The customer completes payment at S504. When the server 400 receives an indication that the payment is complete, the server 500 performs the step of S416 to S420. The item promoter server 650 performs the steps of FIG. 15, as described earlier.

It will be appreciated that various modifications could be made to the online embodiment described above. While the first entity/retailer and the second entity/item promoter are typically separate entities, the software to enable the product promotion system may be provided by a third party to both. If the software is provided by a single third party, information obtained by one of the entities may be stored on the third party software so as to be available to the other entity. For example, contact details of customers obtained by one party may be accessible by both.

There are various advantages associated with embodiments of the product promotion system. In embodiments, pre-planning and implementation of the factory production of large quantities of packaging of products specified designed to indicate that a product is under promotion is not required by manufacturers. Also, an indication of a “win” does not have to be printed on packaging. High cost savings can be obtained.

In embodiments, lead time in effecting a product promotion can be much reduced, since the promotion can be arranged electronically without need for manufacture/printing of special packaging and its distribution. In particular, there is no need for secure distribution of winning ‘packs’ to ensure even spread across stores across a country while at the same time keeping location of winning packs secret even from employees. Promotions can be shorter and more frequent, at lower costs. In embodiments, promotion can be regionalised.

Generally, in embodiments purchase of a particular item(s) can be incentivised by providing the purchaser with entry to a game on purchase of the particular item. The game entry process may be entertaining and that and the associated anticipation provide excitement. Also, in embodiments, a first entity (for example a manufacturer) can arrange product promotion at a second entity (for example a retailer such as a supermarket) in an automated or partially automated manner. This reduces work required at both entities.

In embodiments, there is no need for manufacturers to maintain prize draw offices with staff to handle mailed in winning vouchers or tokens or deal with winning code numbers and then later to hold a fair draw that is transparent and demonstrably so to the public, as may be done conventionally.

In embodiments, need for the offering sale of the promotion packs at every store in the country to match the nationwide TV advertising announcing the promotion and prizes is prevented, since stores can be selected one by one or in regions of a country. Further, in embodiments, need is removed to offer the promotion for a pre-planned number of days or weeks or months with the attendant quantity of sufficient production of promotion packs distributed in time. Accordingly, logistical and time sensitive activity is reduced because promotions are simply booked through the website quickly and simply, such that a product promotion can be run when required, for a chosen duration, at selected stores.

In embodiments, TV advertising (or via various other media) is not required as in-store displays replace that at the point of decision making while shopping. This also allows small manufactures to offer promotion. In particular, a promotion does not have to run until all specially marked packing is sold out. This in turn allows for the first time various ‘test’ promotions at very little cost and also the entry of very small manufacturers who cannot mount nationwide promotions and/or do not have nationwide distribution. Promotions can be very much localised with local producers promoting economically (for example).

The need for shoppers to look for, read and understand how to avail themselves of prizes, and then to follow through if they win a prize by having to mail in or phone in or text message in to the manufacturers prize office with their winning token/voucher/code etc., is avoided. Conventionally, if a product promotion involves a physical prize draw, there is considerable delay in carrying out the draw, and for notification and prize receipt.

Shoppers do not have to remember that a promotion is on. They are informed in store or online. Also, the awarding of prizes may be fast and automatic. Conventionally, a shopper may only find out later on removing packaging and reading the interior of packaging that they have won. If a shopper wins in a store, it is good publicity for the store. The win may be advertised in real-time to others in the store.

In embodiments, entities operating/owning stores may charge manufacturers for a promotion. Thus the owners/operators would have another revenue stream. Manufacturers may nevertheless save on cost, since packaging need not be modified, and advertising need not be paid for through other media. There is also considerable additional ease and flexibility for manufacturers. Further, in embodiments, game entry at checkouts is avoided. Game entry will not therefore cause queues.

Separate PoS and Game Entry Terminals in Stores

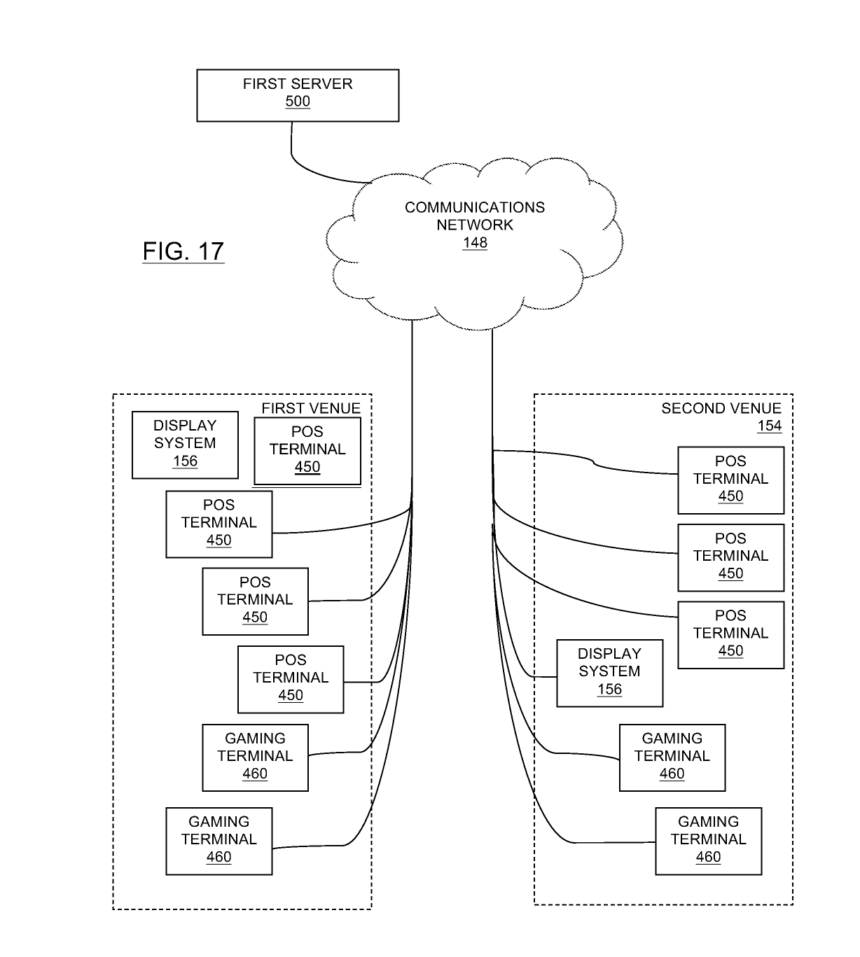

In alternative embodiments the points redemption system and/or product promotion system may be adapted so that game entry takes place at separate gaming terminals. In these embodiments, at least one gaming terminal other than PoS terminals may be provided in a store. Such gaming terminals are indicated in FIG. 17 at 460.

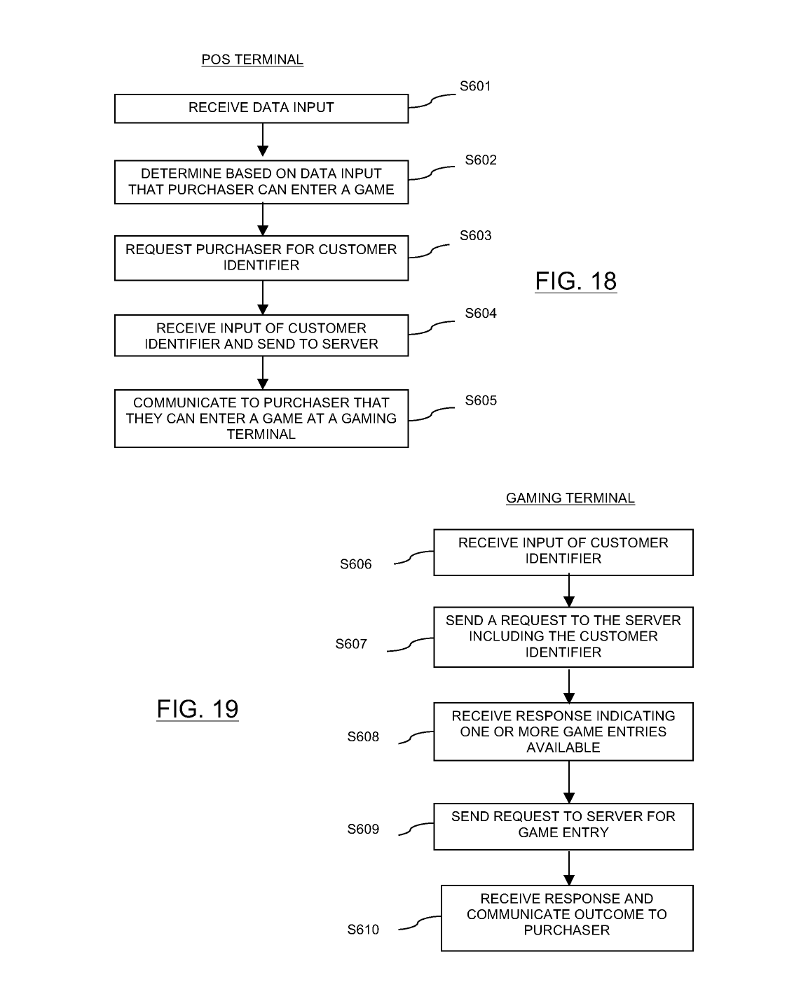

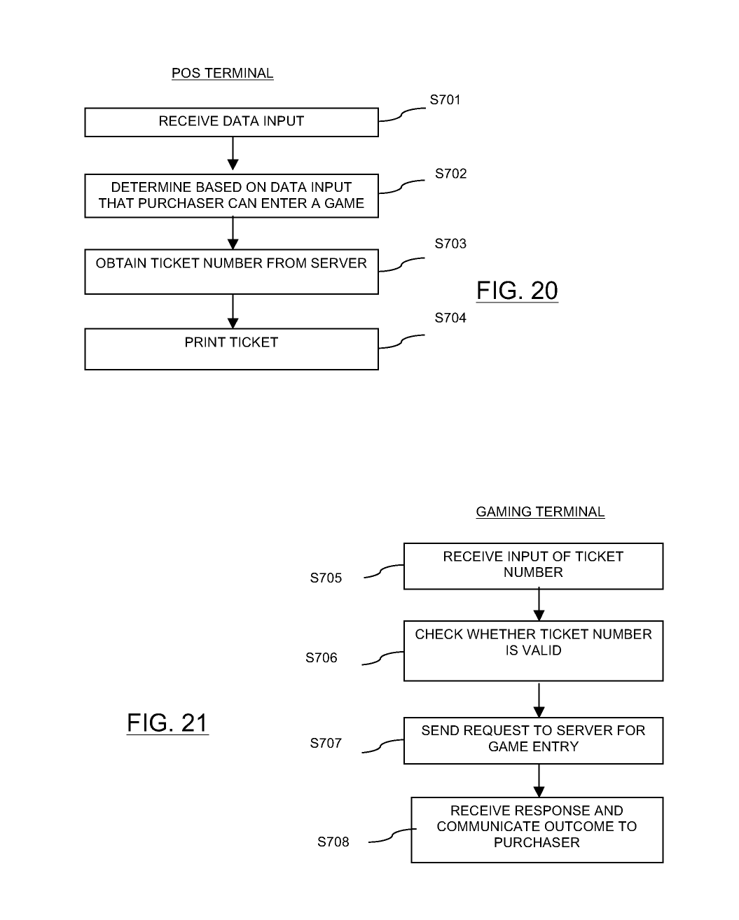

There are a number of possible implementations. An embodiment will now be described with reference to FIGS. 18 and 19. During the purchasing process, a PoS terminal 450 receives input of data (step S601) and determines based on the data that the purchaser can enter a game at step S602. The data input may be an item identifier of an item that is under promotion. Thus, the product promotion system described above can be implemented using separate PoS and gaming terminals.

Alternatively, the data input may be several item identifiers and the terminal determines that the value of the items exceeded a predetermined value. Thus, if the purchaser spends a predetermined amount, the purchaser will receive an opportunity to enter a game. Alternatively, for every predetermined amount that the purchaser spends, the purchaser will receive an opportunity to enter a game. Alternatively, the purchaser may receive the opportunity to enter a game simply for having purchased an item.

At step S603, the terminal 450 communicates a request to the purchaser to input a customer identifier. At step S604, the terminal 450 receives input of the customer identifier, for example as a consequence of the user scanning a customer loyalty card, and transmits the customer identifier to the server 500. The server 500 then records in association with the customer identifier that the customer may enter a game. The server 500 may record this using a counter associated with the customer identifier, so that the server 500 can record a particular number of games that can be entered by the customer.

At step S605, the terminal 450 communicates to the customer that he or she can enter a game at one of the gaming terminals 460. Then the customer goes to a gaming terminal and inputs the customer identifier to the terminal 450 at step S606. The terminal 450 then sends a request to the server 500 including the customer identifier at step S607. The server 500 checks its records associated with the customer identifier to determine whether the customer has the right to enter a game and optionally the number of games that can be entered.

Provided at least one game is available for the customer to enter, the server 500 sends a response to the terminal 460 indicating that the user can enter a game and optionally the number of games that can be entered. The terminal 450 receives the response at step S608. The terminal 460 communicates to the purchaser that a game can be entered and if appropriate the number of games that can be entered. The terminal then receives input from the purchaser that the purchaser wishes to enter a game and processes the game.

The game terminal processes the game at steps S609 and S610. Processing the game entry involves sending a request to a server for game entry with an address of the terminal and the steps of S14 to S21 above. In an alternative embodiment, steps S609 and S610 include the steps of sending a request to the server 500, the server 500 determining an outcome using a random or pseudo-random process and a list of prizes in a prize store to determine whether the purchaser wins a one of the listed prize, and sending a result of the determining to the PoS terminal 450. In another embodiment, the gaming terminal 460 is itself configured to determine the outcome to a game (without recourse to the server). In this case, the gaming terminal may contain prizes or be configured so that small monetary prizes may be won. Steps S609 and S610 therefore do not necessarily require sending and receiving of information from the server 500, but instead the gaming terminal S660 determines an outcome of the game and communicates it to the purchaser.

In alternative embodiments, steps S701 and S702 are like S601 and S602. If the PoS terminal 450 determines at step S602 that the purchaser can enter a game, the PoS terminal 450 sends a request to the server 500 for a ticket number and receives a ticket number in response at step S703. Optionally, the PoS terminal 450 may first ask the purchaser if he or she would like to enter a game and if the purchaser selects to enter a game, obtain the ticket number. The PoS terminal 450 then prints the ticket number for the purchaser at step S704. Alternatively, the PoS terminal may otherwise communicate the ticket number to the purchaser.

It is not essential for the ticket number to be in a numeric form. The ticket number printed could be any kind of machine readable data. The ticket number or machine readable data enabling game entry may be on a receipt. In an embodiment, the server may, instead of sending the ticket number to the PoS terminal 450, send a message to a mobile device of the purchaser comprising a ticket number or machine readable data.

The purchaser then goes to the gaming terminal 460 and inputs the ticket number at step S705. The terminal 460 may include a reader for reading machine readable data from a ticket or a mobile device. Alternatively, the terminal 460 may include an interface to enable the user to enter the ticket number. The gaming terminal 460 then checks whether the ticket number is valid in dependence on whether one or more criteria are met. For example, a criterion may be the ticket has not expired.

A ticket may be designated for use by a particular customer. In this case it is necessary to authenticate the customer. This can be achieved using a customer loyalty card or a payment card, for example. Thus, before or after inputting the ticket identifier to the gaming terminal, the customer inputs a customer identifier, for example using the customer's customer loyalty card. The gaming terminal then sends a request including the ticket identifier and the customer identifier to the server 500 and the server 500 determines whether in its records the ticket identifier and the customer identifier are associated. If so, the server 500 sends an indication to the gaming terminal 460 that the customer is authorised to enter a game using the ticket identifier. Steps S707 and S708 are like steps S609 and S610.

A gaming terminal then determines based on information on the ticket that at least one game is to be entered, and causes processing at the server of the or each game accordingly to determine an outcome. The gaming terminal is configured to receive the outcome and communicate the outcome to the purchaser.

In embodiments for stores in which at least one gaming terminal is provided for game entry (described above), the at least one gaming terminal may be configured to allow a game entry(s) in response to input of information on a receipt issued by a PoS terminal at that store on that day. Alternatively, the at least one gaming terminal may be configured to allow a game entry(s) to any person having a customer loyalty card, in response to input of an identifier of such a card. Alternatively, a ticket can be obtained elsewhere that can be read by the gaming terminal, for example, by in a newspaper. The ticket may alternatively be on product packaging.

In another embodiment, where the customer has a customer account and has identified the account, for example using a customer loyalty card, a points for game entry may be stored at the server in association with the customer's account. The purchaser then identifies the customer account to a one of the gaming terminals, for example using the customer loyalty card. The gaming terminal 460 then determines based on the customer account identifier that at least one token is associated with the customer account and displays a request to the purchaser for confirmation to enter a game(s). The gaming terminal 550 then sends a request to the server 550 including an indication that a game is to be entered and an identifier of the terminal. The request may include an identifier of the purchaser. The server then processes the or each game accordingly to determine an outcome. The other terminal is configured to receive the outcome and communicate the outcome to the purchaser.

General Remarks

In embodiments, the functionality required for in store and/or online retailing, a customer loyalty program if appropriate, and game entry may be provided at different servers.

The exemplary embodiments described above indicate that the present invention may be applied in a store, for example a supermarket. Embodiments of the present invention may also be applied in other types of physical store, including hardware stores and home centres, clothing stores, drug stores, department stores, restaurants of various types, bars and vending machines. Embodiments may also be implemented in customer loyalty systems of financial service companies for example credit card issuers which award points. Air miles may also be redeemed against entry to games.

It should be understood that in all of the above embodiments order of steps may be changed so that a purchaser can enter a game before payment is complete or after payment. However, if a game is entered before payment is complete, the outcome should preferably not be communicated to the purchaser before payment is complete.

In embodiments, persons in a store may enter games without need for redemption of points or to purchase a particular item over a predetermined time period or need for a ticket. Advantageously, this may attract people to stores. In an embodiment, to prevent people who are not customers of a store from entering games over such a time period, a terminal (in online or in store embodiments) may be configured to enable any purchaser of items to enter a game, or to allow any person to enter a game if at least one predetermined criterion is met. For example, the predetermined criterion may be that a minimum amount of money is spent. Alternatively, a person may be able to enter a game(s) simply by swiping a loyalty card during a predetermined period, whether purchasing items or not. There is preferably a limit to the number of game entries allowed per person during such a set time period, or over another time period, for example per month.

In an aspect of the invention, there is provided a method comprising: receiving an input at a terminal identifying an item to be purchased; determining that the item is under promotion; enabling entry to a draw for which a progressive jackpot prize is available; and communicating the outcome of the draw to the customer. The terminal may be a PoS terminal in accordance with description above, for a store such as a retail store, or may be a terminal enabling online shopping.

In another aspect of the invention, there is provided a method comprising: receiving at an electronic terminal input of information indicating that points are to be redeemed against a game for which a prize is available; processing the game to determine an outcome; and communicating to the customer the outcome of the game (at the terminal or another terminal).

In another aspect of the invention, there is provided apparatus for sharing a prize promotion system or a points redemption system between entities each having an online store at which users can buy items from the entity, the apparatus comprising a server for receiving requests to enter games from the entities, processing each of the requests to determine an outcome, and sending a response indicating the outcome to the entity from which the request was received. The outcome may be that a prize is won. In the case that a prize is won, the cost of the prize is preferably shared amongst the entities. The cost may be shared in proportion to the number of requests that the server processes from each entity. The prize may be a jackpot, preferably a progressive jackpot. The requests to enter games may be sent from a plurality of server means each hosting a one of the entity's online stores. In the case of a points redemption system, the requests may be sent to the server when user chooses to redeem points against entry to a game. In the case of a product promotion system, the requests may be sent to the server when a user purchases a promoted item. For example, a server means determines that a promoted item is being purchased and invites the user to enter a game accordingly.

In another aspect, there is provided in a (physical) store a gaming terminal configured to: receive input of a piece of information; determine based on the piece of information that a game is to be entered; process an entry to a game accordingly to generate an outcome; and communicate the outcome to the user. The processing of the entry may include sending a request to a server including an identifier of the gaming terminal, which determines the outcome and sends information indicative of the outcome to the gaming terminal. The determining based on the piece of information may comprise determining based on a information on a voucher (electronic or physical), a customer identifier, a product packaging, or a code entered by the user.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1-224. (canceled)

225. An apparatus for managing item promotion reservation, comprising:
a server apparatus having a processor and a memory containing stored computer readable instructions, the server apparatus being configured to:
connect to a communications network;
handle requests for item promotion reservations initiated at terminals at a plurality of entities;
control promotion of items at at least one store of a different entity based on the item promotion reservations, wherein the controlling promotion comprises controlling advertising of at least one of the items at the at least one store, wherein the advertising includes advertising that a reward will be offered if an advertised item is purchased.

226. The apparatus of claim 225, wherein the at least one store comprises an online store and/or a physical store.

227. The apparatus of claim 225, wherein the requests regarding item promotion reservations comprise information indicative of the reward to be offered.

228. The apparatus of claim 227, wherein the reward is that a game can be entered if the advertised item is purchased.

229. The apparatus according to claim 228, wherein the at least one game comprises a prize draw.

230. The apparatus of claim 225, wherein the server apparatus comprises a bookings database stored thereon, the bookings database storing at least one of:
information indicative of time periods over which advertising of an item takes place;
content for use in advertising of an item;
information indicative of stores in which advertising is to take place;
information identifying at least one reward that will be offered if a particular advertised item is purchased;
information identifying at least one store in which an item is to be promoted by characteristic of the store; and
information identifying at least one product to be promoted.

231. The apparatus of claim 230, wherein the information stored is received in the request from the terminals in accordance with predetermined criteria.

232. The apparatus of claim 225 wherein the server apparatus is configured to control promotion of items at at least one internet-connected terminal at which the item can be purchased via an online store.

233. The apparatus of claim 225, wherein the server apparatus is configured to control advertising at at least one display system in at least one physical store.

234. The apparatus of claim 225, further comprising a plurality of said display systems located in a plurality of stores and connected to the communications network, wherein each display system is configured for advertising of items under the control of the server apparatus.

235. The apparatus of claim 225, wherein the server apparatus is connected to the communications network, further comprising a plurality of point-of-sale (PoS) terminals connected to the communications network, wherein each PoS terminal is configured:
to send, in response to purchase of a promoted item by a purchaser, a request, the request including an indication that a game is to be entered, an identifier of the terminal and information identifying the item purchased,
to receive information indicative of the outcome, and
to communicate the outcome to the customer.

236. The apparatus according of claim 225, further comprising a plurality of internet-connected user terminals enabling purchase of items via an online store, wherein each user terminal is configured:
to send, in response to purchase of a promoted item by a purchaser, a request, the request including an indication that a game is to be entered, an identifier of the terminal and information identifying the item purchased,
to receive information indicative of the outcome, and
to communicate the outcome to the customer.

237. A method of managing item promotion reservation for stores, comprising, at processing apparatus:
handling requests for item promotion reservations initiated at terminals at a plurality of entities; and
controlling promotion of items at at least one different entity based on the item promotion reservations, the controlling including controlling advertising of at least one of the items at the at least one store, wherein the advertising includes advertising that a reward will be offered if an advertised item is purchased.

238. The method according to claim 237, wherein the stores comprises an online store and/or at least one physical store.

239. The method of claim 237, wherein at least some of the requests regarding item promotion reservations comprise information indicative of the reward to be offered.

240. The method of claim 237, further comprising controlling advertising of items at at least one internet-connected terminal at which the item can be purchased via an online store.

241. The method of claim 237 further comprising controlling advertising at at least one display system in at least one store.

242. The method of claim 241, further comprising advertising of items under the control of the server apparatus at a plurality of display system locating in a plurality of stores and connected to the communications network.

243. The method of claim 237, wherein the reward comprises a prize draw for a progressive jackpot.

244. A computer program embodied on a computer readable storage medium, the computer program comprising computer program code means adapted to perform, when said program is run on a processing apparatus:
handling of requests for item promotion reservations initiated at terminals at a plurality of entities; and
controlling of promotion of items at at least one different entity based on the item promotion reservations, the controlling including controlling advertising of at least one of the items at the at least one store, wherein the advertising includes advertising that a reward will be offered if an advertised item is purchased.
